(19) United States
(12) Patent Application Publication
(10) Pub. No.: US 2013/0217765 A1
(43) Pub. Date: Aug. 22, 2013

(54) MULTIFUNCTIONAL NANOCONJUGATES AND USES THEREOF

(71) Applicant: Eric Brown, Whitewater, WI (US)

(72) Inventor: Eric Brown, Whitewater, WI (US)

(21) Appl. No.: 13/765,778

(22) Filed: Feb. 13, 2013

Related U.S. Application Data
(60) Provisional application No. 61/599,567, filed on Feb. 16, 2012.

(51) Int. Cl. C07F 7/28; A01N 55/02

(52) U.S. Cl. CPC C07F 7/28; A01N 55/02
USPC 514/492; 552/209; 428/402

(57) ABSTRACT

The present invention provides multifunctional nanoconjugates and methods of using them to destroy biological and chemical agents. The nanoconjugates include a dye-coated metal oxide nanoparticles conjugated to a substance capable of binding specifically or non-specifically to an agent. Specifically, the nanoconjugates can be photoactivated by visible light to degrade and destroy biological agents, such as but not limited to bacteria and viruses.

### CROSS-REFERENCE TO RELATED APPLICATIONS

This application claims the benefit of U.S. Provisional Patent Application 61/599,567, filed Feb. 16, 2012, which is incorporated herein by reference in its entirety.

### STATEMENT REGARDING FEDERALLY SPONSORED RESEARCH

Not applicable.

### BACKGROUND OF THE INVENTION

### I. Technologies for Biological Decontamination

The colonization and multiplication of bacteria on surfaces is a phenomenon which is in general unwanted and is frequently associated with disadvantageous consequences. For instance, bacteria on, or in packaging frequently cause food contamination, or even infections in the consumer. In biotechnical plants that are to be operated under sterile conditions, bacteria alien to the system constitute a considerable processing risk. Such bacteria may be introduced with raw materials and may remain everywhere if sterilization is inadequate. By means of adhesion, sections of the bacterial population may escape the normal liquid exchange entailed in rinsing and cleaning and can multiply within the system.

In the case of large-scale outlets serving food or drinks there are considerable risks especially when reusable tableware is employed that is not adequately cleaned, rather than using disposable tableware. Also harmful bacteria propagate in hoses and pipes, storage containers and warm, damp environments, such as, public swimming pools. Facilities of this kind are preferred habitats for bacteria, as are certain surfaces in areas through which many people pass, for example in public transport vehicles, hospitals, telephone booths, schools and, especially, in public toilets.

Particular importance is attached to protecting against bacterial adhesion and propagation in nutrition, in human care, especially in the care of children and the elderly, and in medicine. For example, in the care of the sick and elderly or children, the often reduced defenses of those affected necessitate careful measures to counter infections, especially in intensive care wards and in the case of care at home. Also, particular care is required in the use of medical articles and instruments in the case of medical investigations, treatments and interventions, especially when such instruments or articles come into contact with living tissue or with body fluids. In the case of long-term or permanent contact, especially in the case of implants, catheters, stents, cardiac valves and pacemakers, bacterial contamination can become a life-threatening risk to the patient.

There are currently two traditional types of decontamination methods for controlling growth of bacteria on surface: chemical disinfection and physical decontamination. Chemical disinfectants, such as hypochlorite solutions, are useful but are corrosive to most metals and fabrics, as well as to human skin. Physical decontamination, on the other hand, usually involves dry heat up to 160° C. for 2 hours, or steam or super-heated steam for about 20 minutes. Sometimes UV light can be used effectively, but it is dangerous for humans and difficult to develop and standardize for practical use.

However, the use of chemical disinfectants can be harmful to personnel and equipment due to the corrosiveness and toxicity of the disinfectants. Furthermore, chemical disinfectants result in large quantities of effluent which must be disposed of in an environmentally sound manner. Physical decontamination methods are lacking because they require large expenditures of energy. Both chemical and physical methods are difficult to use directly at the contaminated site due to bulky equipment and/or large quantities of liquids which must be transported to the site.

The ongoing worldwide nanotechnology revolution is predicted to impact several areas of biomedical research and other science and engineering applications. Metal oxide nanoparticles have attracted significant attention because of their atom-like size-dependent properties. Several studies have employed metal oxidize nanoparticles to destroy biological agents. Preferred materials for use in connection with the those applications include the metal oxides and metal hydroxides of Mg, Sr, Ba, Ca, Ti, Zr, Fe, V, Mn, Ni, Cu, Al, Si, Zn, Ag, Mo, Sb, Cr, Co and mixtures thereof, such as those disclosed in U.S. Pat. Nos. 6,093,236; 5,759,939; 6,653,519; 6,087,294 and 6,057,488 (all of which are incorporated by reference in their entirety for all purposes). The metal oxide nanoparticles have reactive atoms stabilized on the surfaces and the reactive atoms include oxygen ion moieties, ozone, halogens, and group I metals. The mechanism of these degrading reactions is based on the electronic properties of the nanoparticles' surface due to the physical confinement of electrons and holes in potential wells defined by crystallite boundaries, and thus the efficiencies of decontamination are significantly temperature-dependent. While these methods can be carried out over a wide range of temperatures from −40° C. to 160° C., it takes more than 12 hours at 37° C. or lower temperature to show the effective decontamination which is not practical.

### II. Photocatalysis of TiO₂ Nanoparticles

Metal oxide photocatalysis is based on the use of metal oxides (for example titanium dioxide, TiO₂) as light-activated catalysts in the destruction of organic and inorganic materials and in organic chemistry synthesis, which has applicability in environmental remediation (aqueous and air-borne) and self-cleaning surfaces. The technique is already widely used in commercial applications, but is still hampered by one significant limitation that these materials generally absorb primarily ultra-violet (UV) light.

In more detail, metal oxide photocatalysis is the utilization of photogenerated strongly oxidizing hydroxyl radicals, which can be applied to a wide range of scenarios, including organic degradation (for pollution remediation) and in organic synthesis. Light induced charge separation, followed by generation of hydroxyl and/or superoxide radicals is in the normal course of event reliant on UV light, given the energy gap (band gap) of metal dioxide. Strategies to enhance the photocatalytic activity include doping to reduce the energy required for charge separation and incorporation of nanoparticles to lengthen the period of charge separation. The size of the materials is also a factor, as for degradation of materials, the pollutant needs to be very near to, or absorbed onto the surface of the metal oxide, and nanoparticle materials mean that a greater surface area can be exploited.

For example, nanoparticles of TiO₂ is popular catalyst of choice because it is cheap, nontoxic, and has redox properties that are favorable both for oxidation of many organic pollutants and for reduction of a number of metal ions or organics in aqueous solution. It has been widely used in applications based on the photocatalytic reactions, such as clean up of water contaminated with hazardous industrial by-products. TiO₂ nanoparticles also have been investigated as a promising new tool for cancer detection and treatment, due to their structures that enable surface conjugation of multiple ligands and specific targeting of the nanoparticles [1-8].

However, these applications require TiO₂ nanoparticles to be activated primarily through excitation by UV light (a known mutagen) that produces or non-specifically produces reactive oxygen species that are capable of inducing damage to neighboring biological agents, and thus limits their use in biological system [9-11]. It would be advantageous to develop dye-coated compositions which are catalyzed by a lower intensity visible light source (instead of mutagen-inducing UV light), thus broadening their use in biological applications. Therefore, due to the drawbacks of existing methods, there is a need for compositions and methods which are safe, efficient and effective against a wide variety of biological agents, such as harmful bacteria.

### SUMMARY OF THE INVENTION

We disclose herein nanoconjugates and methods for destructive sorption of target biological agents. The nanoconjugates are dye-coated metal oxide nanoparticles, wherein the coating allows photoactivation of the nanoparticles through exposure to light. In particular, the present invention provides nanoconjugates and method for absorbing and destroying either bacteria or nucleic acids that may be transferred between bacteria increasing bacterial resistance. To this end, the invention contemplates the use of finely divided nanoscale metal oxide, wherein metal oxide nanoparticles are dye-coated that can be activated upon exposure to light at any wavelength(s). The light or light energy of the present invention can be provided by any electromagnetic radiation source including visible light and non-visible radiation or light. The light can be any wavelength(s) that can be absorbed by at least one dye coated on nanoparticles. A particular advantage of this invention is that dye-coated nanoparticles can be specifically designed to not depend upon mutagen-inducing UV light activation, but rather enables lower intensity, visible light activation [20,21].

In one embodiment, the invention provides for a multifunctional nanoconjugate comprising: a metal oxide nanoparticle; and at least one dye ligand conjugated to the metal oxide nanoparticle.

In another embodiment, the invention provides for a method of preparing a multifunctional nanoconjugate comprising the steps of: providing a metal oxide nanoparticle; providing a dye ligand; and reacting the metal oxide nanoparticle with the dye ligand, so as to attach at least one dye ligand to the metal oxide nanoparticle to form a dye-coated metal oxide nanoparticle.

In yet another embodiment, the invention provides a method for destructive sorption of a target agent comprising: providing a quantity of nanoconjugates, wherein the nanoconjugates comprises a metal oxide nanoparticle and at least one dye ligand conjugated to the metal oxide nanoparticle; and contacting the nanoconjugates with a target agent.

In one aspect, the metal oxide nanoparticle may be TiO₂. Alternatively, other metal oxides expected to have the same or similar effect for the purpose used here are, for example, MgO, CaO, ZrO₂, FeO, V₂O₃, V₂O₅, Mn₂O₃, Fe₂O₃, NiO, CuO, Al₂O₃, ZnO and alike, and mixtures thereof.

In another aspect, the metal oxide nanoparticles are between 0.1 and 1000 nm (e.g., approximately 1000 nm, 500 nm, 100 nm, 20 nm, 10 nm 5 nm, or 1 nm) in diameter. Specifically, the TiO₂ nanoparticles should have an average crystallite size of up to about 20 nm, preferably from about 3-8 nm, and more preferably 6 nm.

In another related aspect, the at least one dye ligand, which may be electrostatically or covalently bound to the nanoparticles, are photosensitive. These are fluorescent dyes (e.g., conjugated to or coating nanoconjugates) that release reactive oxygen species upon excitation by light are used to both image and destroy at least one target agent. One example of a suitable dye is Alizarin red s (ARS). Other dyes include but are not limited to alizarin blue black b (ABBB), mordant orange 1 (MO1), alizarin yellow gg (AYGG), N-719, resazurin sodium salt (RSS), and acid green 25 (AG25), or a mixture thereof. In some embodiments, more than one kind of dye is electrostatically or covalently bound to the nanoparticles to further enhance decontamination of the target agent.

It is envisioned that two (or more) dyes can be incorporated into the nanoconjugate to facilitate cellular entry of both dyes and nuclear delivery of the dye possessing weaker metal oxide nanoparticle interaction. This highlights another benefit of using multiple dyes in the nanoconjugate and also highlights the benefit of incorporating dyes into the nanoconjugate that have varying strengths of interaction with the metal oxide nanoparticle. For example, dyes of interest can be incorporated in the nanoconjugate via a covalent bond through mono- or bi-dentate ligand action and other dyes of interest can be incorporated into the nanoconjugate through sorption of the sulfonate group(s). In one example, dual fluorescence coated TiO₂ nanoparticles (for example ARS & ABBB) can enable enhanced nuclear delivery (or nucleolar in the case of bacteria) of the absorbed fluorescence dye (e.g., ABBB, absorbed through sulfonate group) and perinuclear retention of the remaining covalently bound (mono or bi-dentate) dye-nanoparticle nanoconjugate (ARS-TiO₂).

In another related aspect, the target agent may be biological or chemical in origin. Non-limiting biological agents include bacteria (Gram-positive and Gram-negative), viruses, nucleic acids, prions, toxins, cells or the mixture thereof. The Gram-positive bacteria includes, for example, B. subtilis, B. globigii and B. cereus, or a mixture thereof. The Gram negative bacteria includes E. coli, and E. Herbicola, or a mixture thereof. Non-limiting toxins include Aflatoxins produced by certain strains of the molds Aspergillus flavus and Aspergillus parasiticus, which are toxic and carcinogenic.

In another related aspect, the contacting step can take place over a wide range of temperatures and pressures. For example, the nanoconjugate can be taken directly to a biologically or chemically contaminated site and contacted with the contaminant and/or contaminated surfaces at ambient (such as room temperatures) temperatures and pressures. If the contacting step is carried out under ambient conditions, the nanoconjugate should be allowed to contact the target substance for at least about 0.5 minutes, preferably from about 1-100 minutes, and more preferably from about 1.5-20 minutes. If the contacting step is carried out under high temperatures conditions, then the nanoconjugate should be allowed to contact the target substance for at least about 4 seconds, preferably for about 5-20 seconds, and more preferably for about 5-10 seconds. Longer exposure times of contaminants to nanoconjugates further increase sterilization. It is envisioned that the disclosed nanoconjugates can function at temperature ranging of −40-0° C., 0-40° C., 40-100° C. and 100-160° C. or higher.

If the target substance is a biological agent, the contacting step results in at least about a 70% reduction in the viable units of the biological agent, preferably at least about a 80%, 85% or 90% reduction, and more preferably at least about a 95% reduction. If the target substance is a chemical agent, the contacting step results in at least about 70% reduction in the concentration of the chemical agent, preferably at least about a 80%, 85%, 90% or 95% reduction, and more preferably at least about a 99% reduction.

Those skilled in the art will appreciate the benefits provided by the nanoconjugates and methods of the invention. In accordance with the invention, healthcare providers, military personnel and others can utilize the nanoconjugates to neutralize highly toxic substances such as nerve agents and biological agents. These nanoconjugates can be utilized in their non-toxic ultrafine powder form to decontaminate areas exposed to these agents, or the powders or highly pelletized composites can be utilized in air purification or water filtration devices. Other countermeasure and protective uses for the nanoconjugates include personnel ventilation systems and wide-area surface decontamination. Furthermore, the nanoconjugates remain airborne for at least one hour, thus providing effective airborne decontamination of chemical or biological agents. Alternately, the nanoconjugates can be formulated into an aerosol spray, powder, liquid, gel, cream or incorporated in or on clothing in order to provide protection to humans and animals at risk of contacting a dangerous agent.

Unlike currently available decontamination methods, the methods of the invention utilize nanoconjugates that are non-toxic to humans and non-corrosive to equipment, thus permitting the decontaminated equipment to be put back into use rather than discarded. Furthermore, because the nanoconjugates are easy to disperse and readily transportable, and because little or no water is required to practice the invention, it is relatively simple to destroy the contaminants at the contaminated site.

### BRIEF DESCRIPTION OF THE DRAWINGS

FIG. 1 is TEM images depicting the approximately 6 nm TiO₂ nanoparticles used in the study. Scale bar=20 nm.

FIG. 2 demonstrates the interaction between ARS and TiO₂ nanoparticles and lack of interaction between orange G and TiO₂ nanoparticles is demonstrated through three different assays. a: A sedimentation assay illustrated that upon centrifugation of samples at 0.2 g, ARS (tube 2) remained in the supernatant, while TiO₂ nanoparticles (tube 3) and ARS-TiO₂ nanoparticle conjugates (tube 4) formed a pellet at the bottom of the tube (tube 1=dH₂O). b: Under the same conditions, no orange G-TiO₂ interaction was seen in tube 4 (tube 1=dH₂O, tube 2=orange G, tube 3=TiO₂ nanoparticles). c: ARS-coated TiO₂ nanoparticles (red line) demonstrated a red shift in spectral absorbance compared to their ARS counterparts (blue line). d: Under the same conditions, no shift in absorbance was witnessed for orange G-TiO₂ nanoparticles (red line) versus orange G (blue line). e: Upon polyacrylamide gel electrophoresis of samples, ARS (lane 2) migrated through the gel, while TiO₂ nanoparticles (lane 3) and dye-TiO₂ nanoparticles (lane 4) remained trapped in the wells of the gel (tube 1=dH₂O). f: Under the same conditions, orange G did not remain associated with TiO₂ nanoparticles in the gel well, but rather migrated into the gel (lane 4). g: Molecular structure of ARS is shown (Sigma). h: Molecule structure of orange G is shown (Sigma).

FIG. 3 characterizes dye-TiO₂ interactions, (a) ARS and (b) ARS-coated TiO₂ nanoparticles exhibited different fluorescence emissions when excited by white light.

FIG. 4 shows increased nicking of plasmid DNA was evident when ARS-coated TiO₂ nanoparticles were exposed to visible light for 10 min (lane 4, yellow) compared to no light (lane 4, white), and this increase in nicking was greater than when ARS was exposed to visible light (lane 2, yellow). All lanes contained plasmid DNA+either: lane 1=no addition, lane 2=ARS, lane 3=TiO₂ nanoparticles, lane 4=ARS-coated TiO₂ nanoparticles, yellow=visible light exposure, white=no light exposure. b: Further nicking of plasmid DNA was evident when ARS-coated TiO₂ nanoparticles were exposed to visible light for 20 min and little supercoiled plasmid remained (lane 4, yellow) compared to no light (lane 4, white). The increase in plasmid nicking witnessed in the presence of visible light activated ARS-coated nanoparticles was greater than when ARS was exposed to visible light (lane 2, yellow). All lanes contained plasmid DNA+either: lane 1=no addition, lane 2=ARS, lane 3=TiO₂ nanoparticles, lane 4=ARS-coated TiO₂ nanoparticles, yellow=visible light exposure, white=no light exposure. c: The relative spectral radiance of a quartz-halogen bulb (Dolan-Jenner, modified). d: Increased nicking of plasmid DNA was evident when ARS-coated TiO₂ nanoparticles were exposed to UV light for 10 min (lane 4, yellow) compared to no light (lane 4, white). This increase in plasmid nicking was greater than when ARS was exposed to UV light (lane 2, yellow), but approximately the same as when TiO₂ nanoparticles were exposed to UV light (lane 3, yellow). Samples containing solely plasmid DNA that were exposed to UV light did demonstrate detectable levels of plasmid nicking (lane 1, yellow). All lanes contained plasmid DNA+either: lane 1=no addition, lane 2=ARS, lane 3=TiO₂ nanoparticles, lane 4=ARS-coated TiO₂ nanoparticles, yellow=visible light exposure, white=no light exposure.

FIG. 5 shows that a-l: Perinuclear localization of ARS-coated TiO₂ nanoparticles was evident in viewing a Z-stack of HeLa cells (1 mm optical slices). Localization of ARS-TiO₂ nanoconjugates is indicated by white arrows. m-n: Perinuclear localization of ARS-TiO₂ nanoconjugates was also viewed in 3D reconstructions of individual HeLa cells, while some cells also demonstrated membrane encompassing ARS-coated TiO₂ nanoparticles (central yellow arrow in N). Blue=DNA, green=emerin, red=ARS-coated TiO₂ nanoparticles.

FIG. 6 shows alterations in emerin integrity and distribution detected in HeLa cells exposed to ARS-coated TiO₂ nanoparticles and 150 W halogen white light for 10 min (h), as nuclear rim staining was decreased and more punctuated (white arrows), compared HeLa cells exposed to ARS-coated TiO₂ nanoparticles, but no white light (d). Some DNA condensation was observed in cells exposed to ARS-coated TiO₂ nanoparticles (d, h), and some enlarged nuclei were also observed when ARS-coated TiO₂ nanoparticles were exposed to light (h). HeLa cells exposed to dH₂O (a, e), ARS (b, f), and TiO₂ nanoparticles (c, g) exhibited normal emerin integrity and distribution.

FIG. 7 shows alterations in lamin B1 integrity and distribution detected in HeLa cells exposed to ARS-coated TiO₂ nanoparticles and white light (h), as nuclear rim staining was decreased and more punctuated, compared to HeLa cells exposed to ARS-coated TiO₂ nanoparticles, but no white light (d). HeLa cells exposed to dH₂O (a, e), ARS (b, f), and TiO₂ nanoparticles (c, g) exhibited normal emerin integrity and distribution.

FIG. 8 shows alterations in lamin B1 integrity and distribution detected in HeLa cells exposed to ARS-coated TiO₂ nanoparticles and white light, as nuclear rim staining was decreased and more punctuated (compared to control cells in FIG. 7). Additionally, some cells exposed to ARS-coated TiO₂ nanoparticles and white light exhibited nuclei with DNA “leaking” outside of the nuclear membrane, and other cells possess fragmented lamin B1 lamina associated with ARS-TiO₂ nanoparticles (white arrows). Inset image is an enlargement of the upper right cell.

FIG. 9 demonstrates the interaction between alizarin blue black B and TiO₂ nanoparticles is demonstrated through three different assays. a) A sedimentation assay illustrated that upon centrifugation of samples at 0.2 g, alizarin blue black B (tube 2) remains in the supernatant, while TiO₂ nanoparticles (tube 3) and alizarin blue black B-TiO₂ nanoparticle conjugates (tube 4) formed a pellet at the bottom of the tube (tube 1=dH₂O). b) Alizarin blue black B-coated TiO₂ nanoparticles (purple line) demonstrated a red shift in spectral absorbance compared to their alizarin blue black B counterparts (red line). c) Upon polyacrylamide gel electrophoresis of samples, alizarin blue black B (lane 2) migrated through the gel, while TiO₂ nanoparticles (lane 3) and alizarin blue black B-TiO₂ nanoparticles (lane 4) remained trapped in the wells of the gel (tube 1=dH₂O). d) Molecular structure of alizarin blue black B is shown (Sigma).

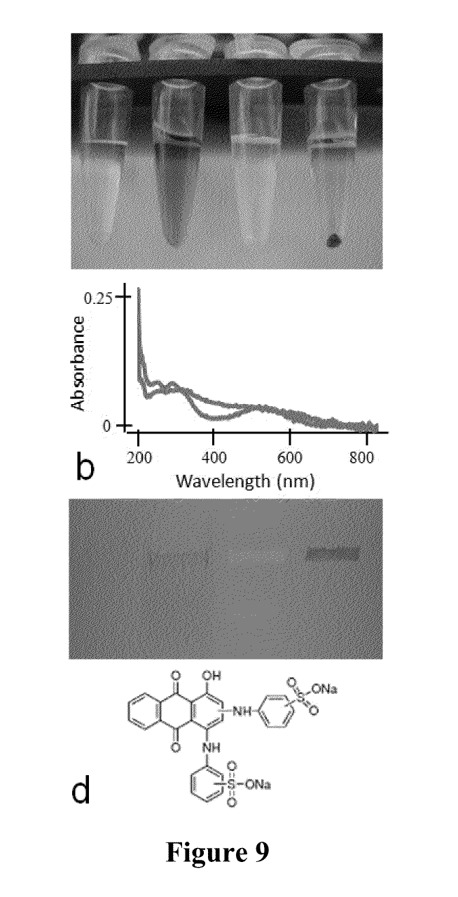

FIG. 10 demonstrates the interaction between mordant orange 1 and TiO₂ nanoparticles is demonstrated through three different assays. a) A sedimentation assay illustrated that upon centrifugation of samples at 0.2 g, mordant orange 1 (tube 2) remains in the supernatant, while TiO₂ nanoparticles (tube 3) and mordant orange 1-TiO₂ nanoparticle conjugates (tube 4) formed a pellet at the bottom of the tube (tube 1=dH₂O). b) Mordant orange 1-coated TiO₂ nanoparticles (red line) demonstrated a red shift in spectral absorbance compared to their mordant orange 1 counterparts (blue line). c) Upon polyacrylamide gel electrophoresis of samples, mordant orange 1 (lane 2) migrated through the gel, while TiO₂ nanoparticles (lane 3) and mordant orange 1-TiO₂ nanoparticles (lane 4) remained trapped in the wells of the gel (tube 1=dH₂O). d) Molecular structure of mordant orange 1 is shown (Sigma).

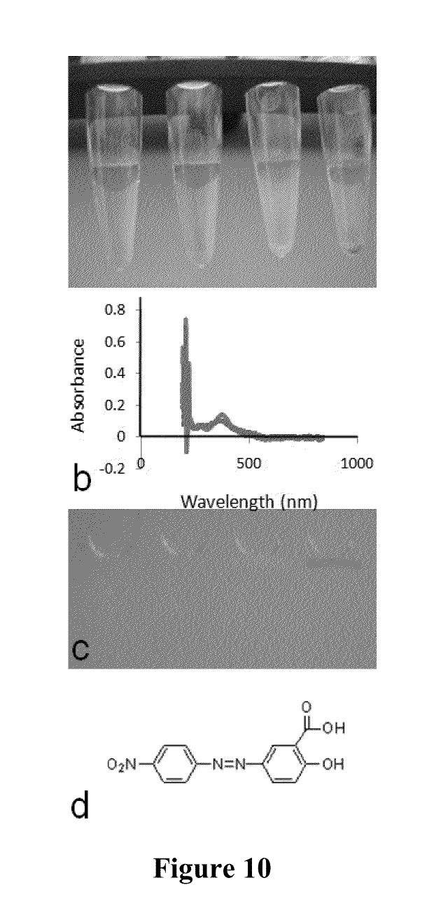

FIG. 11 demonstrates the interaction between alizarin yellow GG and TiO₂ nanoparticles is demonstrated through three different assays. a) A sedimentation assay illustrated that upon centrifugation of samples at 0.2 g, alizarin yellow GG (tube 2) remains in the supernatant, while TiO₂ nanoparticles (tube 3) and alizarin yellow GG-TiO₂ nanoparticle conjugates (tube 4) formed a pellet at the bottom of the tube (tube 1=dH₂O). b) Alizarin yellow GG-coated TiO₂ nanoparticles (red line) demonstrated a red shift in spectral absorbance compared to their alizarin yellow GG counterparts (purple line). c) Upon polyacrylamide gel electrophoresis of samples, alizarin yellow GG (lane 2) migrated through the gel, while TiO₂ nanoparticles (lane 3) and alizarin yellow GG-TiO₂ nanoparticles (lane 4) remained trapped in the wells of the gel (tube 1=dH₂O). d) Molecular structure of alizarin yellow GG is shown (Sigma).

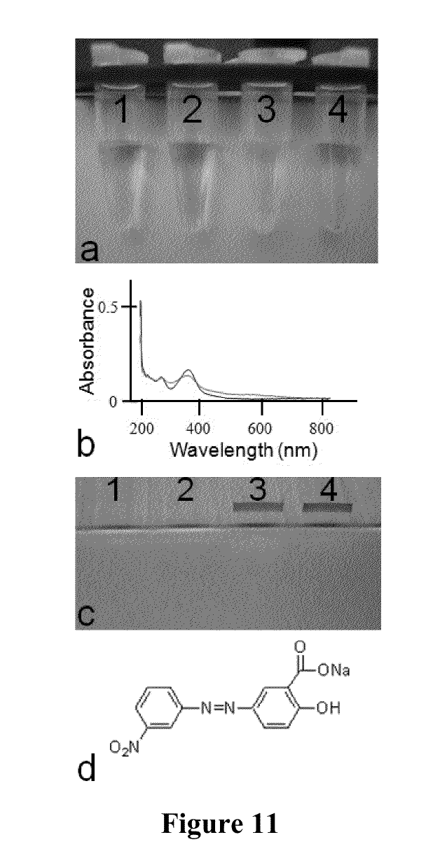

FIG. 12 demonstrates the interaction between N719 and TiO₂ nanoparticles is demonstrated through three different assays. a) A sedimentation assay illustrated that upon centrifugation of samples at 0.2 g, N719 (tube 2) remains in the supernatant, while TiO₂ nanoparticles (tube 3) and N719-TiO₂ nanoparticle conjugates (tube 4) formed a pellet at the bottom of the tube (tube 1=dH₂O). b) N719-coated TiO₂ nanoparticles (light blue line) demonstrated a red shift in spectral absorbance compared to their N719 counterparts (red line). c) Upon polyacrylamide gel electrophoresis of samples, N719 (lane 2) migrated through the gel, while TiO₂ nanoparticles (lane 3) and N719-TiO₂ nanoparticles (lane 4) remained trapped in the wells of the gel (tube 1=dH₂O). d) Molecular structure of N719 is shown (Sigma).

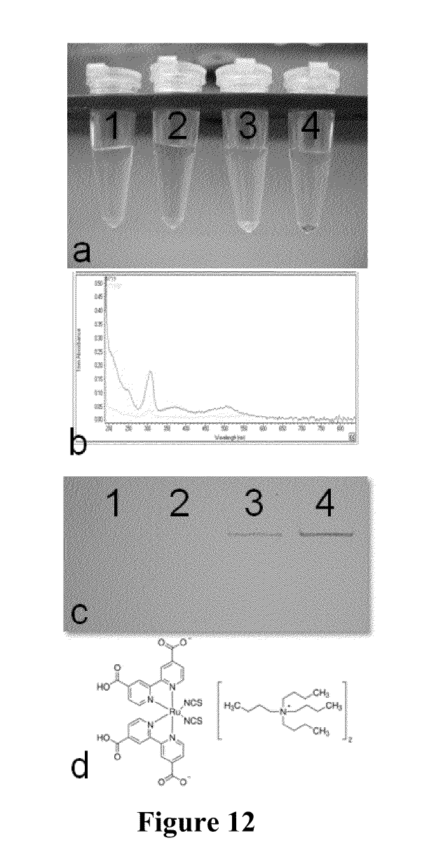

FIG. 13 demonstrates the interaction between resazurin sodium salt and TiO₂ nanoparticles is demonstrated through three different assays. a) A sedimentation assay illustrated that upon centrifugation of samples at 0.2 g, resazurin sodium salt (tube 2) remains in the supernatant, while TiO₂ nanoparticles (tube 3) and resazurin sodium salt-TiO₂ nanoparticle conjugates (tube 4) formed a pellet at the bottom of the tube (tube 1=dH₂O). b) resazurin sodium salt-coated TiO₂ nanoparticles (blue line) demonstrated a shift in spectral absorbance compared to their resazurin sodium salt counterparts (red line). d) Molecular structure of resazurin sodium salt is shown (Sigma).

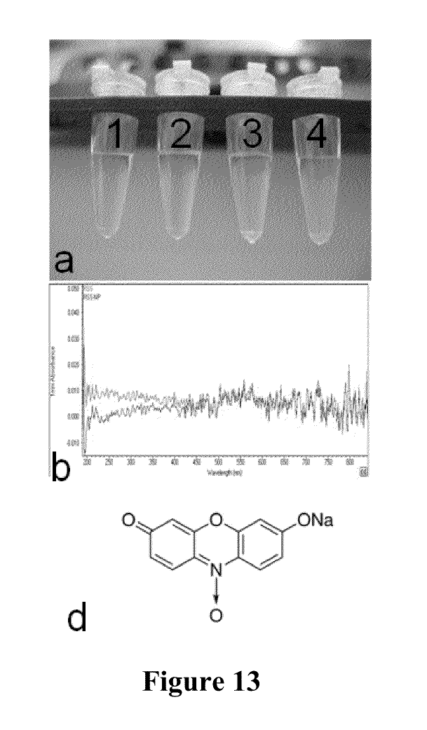

FIG. 14 shows dual fluorescence dye coated TiO₂ nanoparticles such as (a) (N719 & ABBB)-TiO₂, (b) (ABBB & MO1)-TiO₂, and (c) (ABBB & AYGG)-TiO₂. All samples were mixed for 24 hours. A sedimentation assay illustrated that upon centrifugation of samples at 0.2 g, the dual dyes of interest (tube 2) remain in the supernatant, while TiO₂ nanoparticles (tube 3) and dual dyes of interest-TiO₂ nanoparticle conjugates (tube 4) formed a pellet at the bottom of the tube (tube 1=dH₂O).

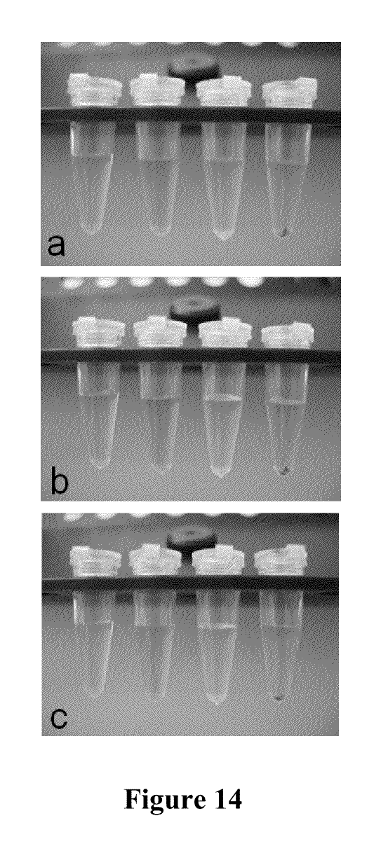

FIG. 15 characterizes dye-TiO₂ interactions, a) alizarin blue black B and b) alizarin blue black B-coated TiO₂ nanoparticles exhibited different fluorescence emissions when excited by white light.

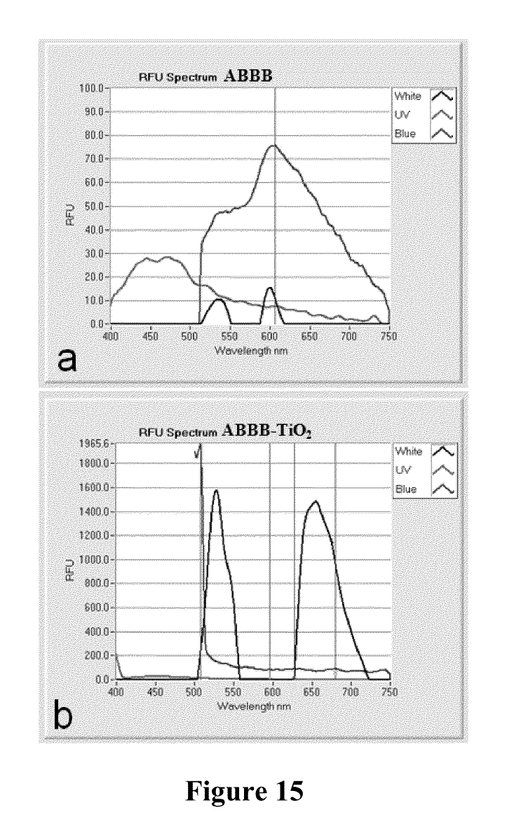

FIG. 16 characterizes dye-TiO₂ interactions, a) mordant orange 1 and b) mordant orange 1-coated TiO₂ nanoparticles exhibited different fluorescence emissions when excited by white light.

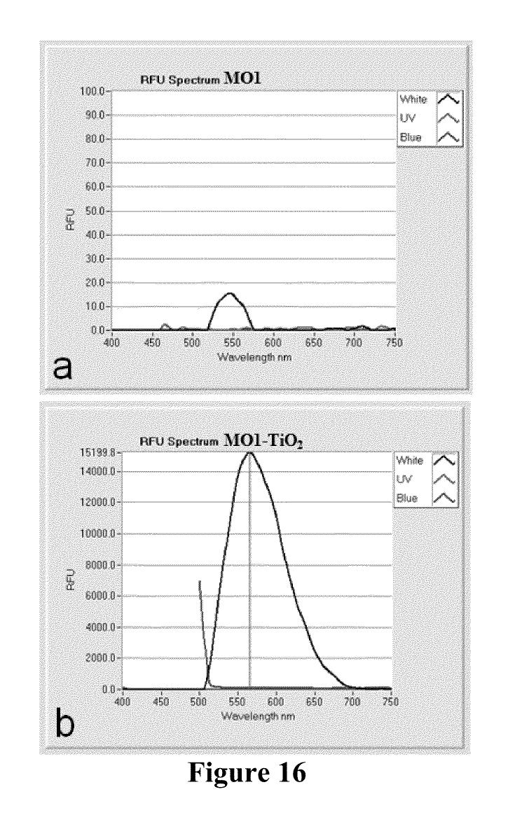

FIG. 17 characterizes dye-TiO₂ interactions, a) alizarin yellow GG and b) alizarin yellow GG-coated TiO₂ nanoparticles exhibited different fluorescence emissions when excited by white light.

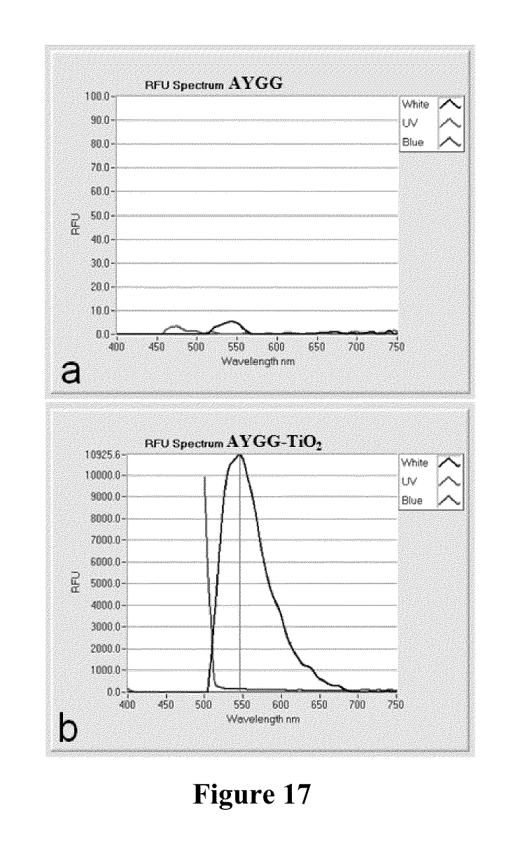

FIG. 18 characterizes dye-TiO₂ interactions, a) N719 and b) N719-coated TiO₂ nanoparticles exhibited different fluorescence emissions when excited by white light.

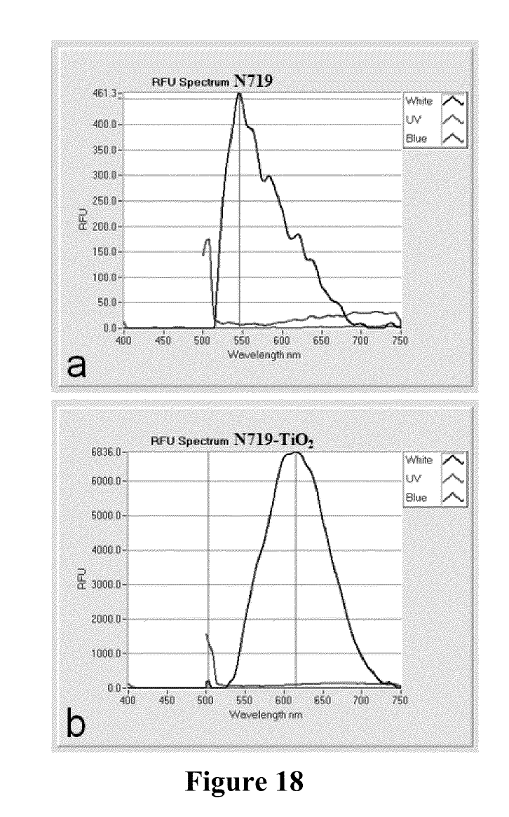

FIG. 19 characterizes dye-TiO₂ interactions, a) resazurin sodium salt and b) resazurin sodium salt-coated TiO₂ nanoparticles exhibited different fluorescence emissions when excited by white light.

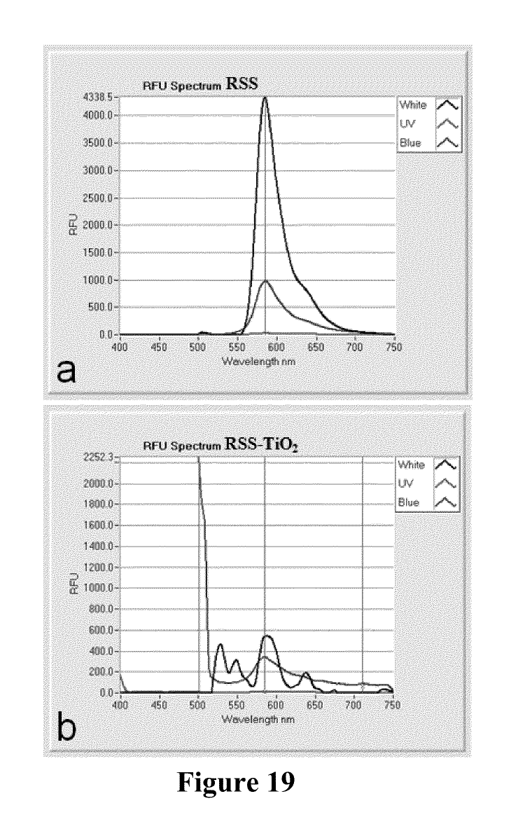

FIG. 20 shows increased nicking of plasmid DNA was evident when alizarin blue black B-coated TiO₂ nanoparticles were exposed to visible light for 10 minutes (lane 4, yellow) compared to no light (lane 4, white), and this increase in nicking was greater than when alizarin blue black B was exposed to visible light (lane 2, yellow). All lanes contained plasmid DNA+either: lane 1=no addition, lane 2=alizarin blue black B, lane 3=TiO₂ nanoparticles, lane 4=alizarin blue black B-coated TiO₂ nanoparticles, yellow=visible light exposure, white=no light exposure.

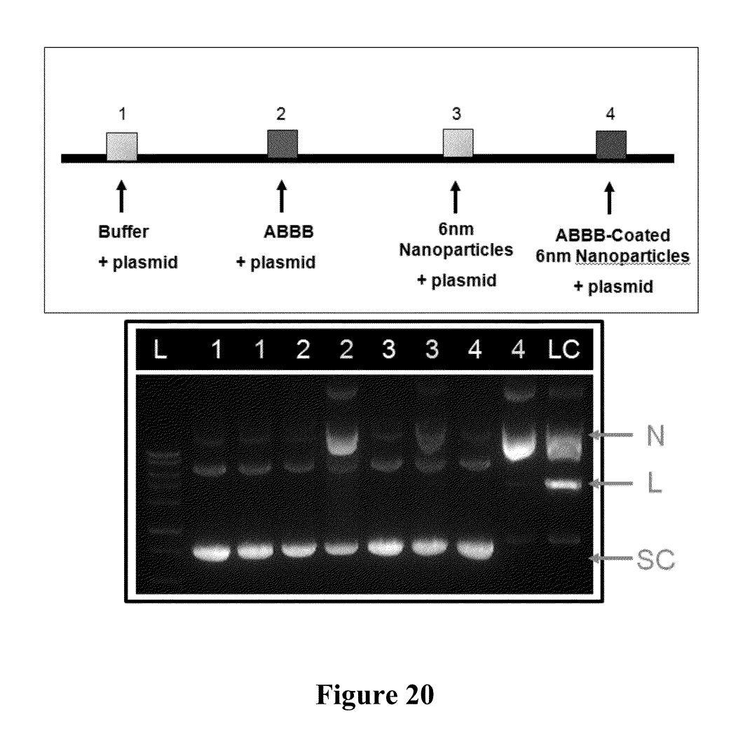

FIG. 21 shows increased nicking of plasmid DNA was evident when mordant orange 1-coated TiO₂ nanoparticles were exposed to visible light for 10 minutes (lane 4, yellow) compared to no light (lane 4, white), and this increase in nicking was greater than when mordant orange 1 was exposed to visible light (lane 2, yellow). All lanes contained plasmid DNA+either: lane 1=no addition, lane 2=mordant orange 1, lane 3=TiO₂ nanoparticles, lane 4=mordant orange 1-coated TiO₂ nanoparticles, yellow=visible light exposure, white=no light exposure.

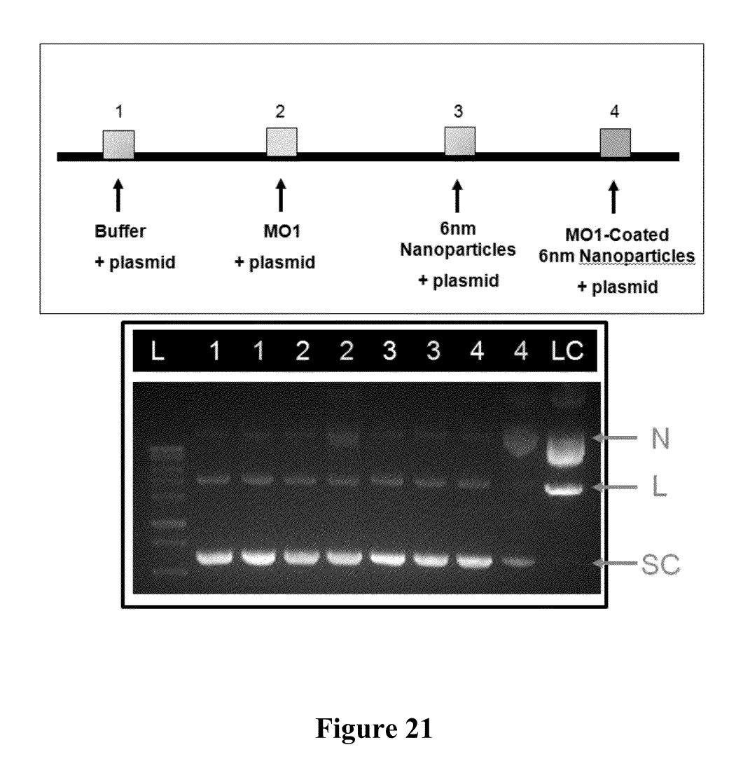

FIG. 22 shows increased nicking of plasmid DNA was evident when alizarin yellow GG-coated TiO₂ nanoparticles were exposed to visible light for 10 minutes (lane 4, yellow) compared to no light (lane 4, white), and this increase in nicking was greater than when alizarin yellow GG was exposed to visible light (lane 2, yellow). All lanes contained plasmid DNA+either: lane 1=no addition, lane 2=alizarin yellow GG, lane 3=TiO₂ nanoparticles, lane 4=alizarin yellow GG-coated TiO₂ nanoparticles, yellow=visible light exposure, white=no light exposure.

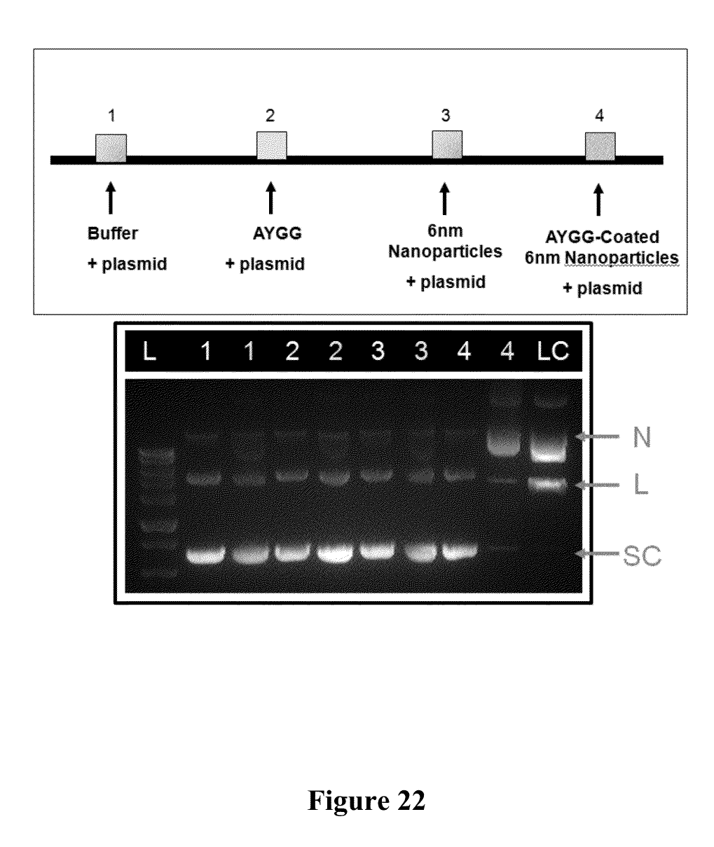

FIG. 23 shows atomic force microscope images acquired in Peakforce Tapping mode using a ScanAsyst Air Probe. Plasmid DNA digested with a restriction enzyme XhoI (left), plasmid DNA in the presence of ARS-TiO₂ nanoconjugates in dark conditions (middle), and plasmid DNA in the presence of ARS-TiO₂ nanocojugates exposed to a 150 W halogen bulb for 10 minutes are shown (right). Plasmid degradation is seen when the plasmid is exposed to either a restriction enzyme or visible light activated ARS-TiO₂ nanoconjugates. However, no plasmid degradation is visualized when plasmid DNA is exposed to ARS-TiO₂ nanoconjugates in dark conditions.

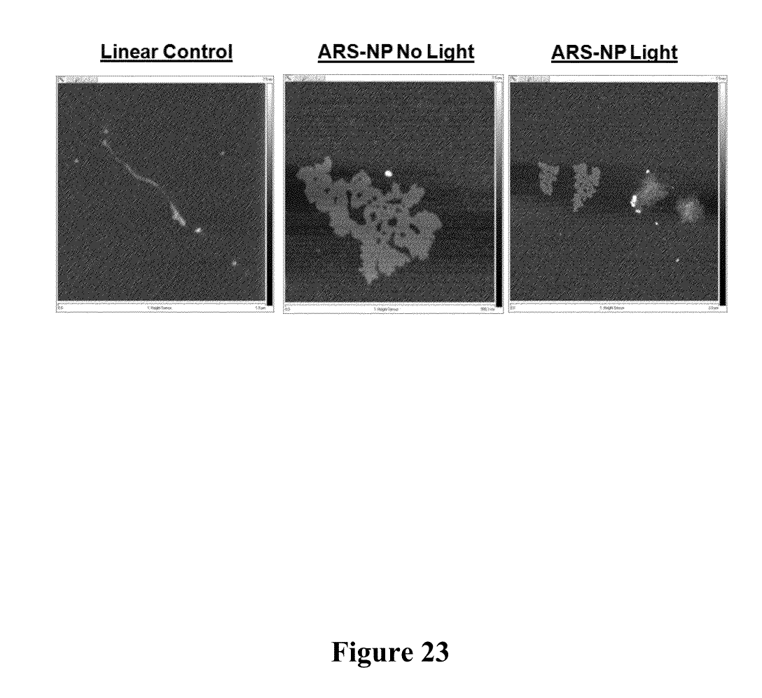

FIG. 24 shows bacterial (E. Coli) samples were incubated with either: 1) dH₂O; 2) ARS; 3) TiO₂ nanoparticles; or 4) ARS-coated TiO₂ nanoparticles and then exposed to a 150 W halogen bulb for ten minutes. While bacterial colonies are witnessed on plates 1-3, no bacterial growth is evident in plate 4, suggesting that release of reactive oxygen species upon visible light photoactivation of dye-coated TiO₂ nanoparticles results in bacteria death.

FIG. 25 shows that HeLa cells were exposed to either dH₂O, TiO₂ nanoparticles, alizarin red s (ARS), ARS-TiO₂, alizarin blue black B (ABBB), ABBB-TiO₂, ARS AND ABBB, or (ARS & ABBB)-TiO₂. Dyes alone or in combination are not detected in HeLa cells using the available fluorescence emission filters. However, ARS-TiO₂, ABBB-TiO₂, and (ARS-ABBB)-TiO₂ nanoconjugates are detected in the red fluorescence emission filter. In the case of (ARS & ABBB)-TiO₂ nanoparticles, a nuclear ABBB signal is seen in the blue fluorescence emission filter channel. This indicates that dual fluorescence coated TiO₂ nanoparticles (ARS & ABBB) can enable nuclear delivery of the absorbed fluorescence dye (ABBB) and perinuclear retention of the remaining covalently bound dye-nanoparticle nanoconjugate (ARS-TiO₂).

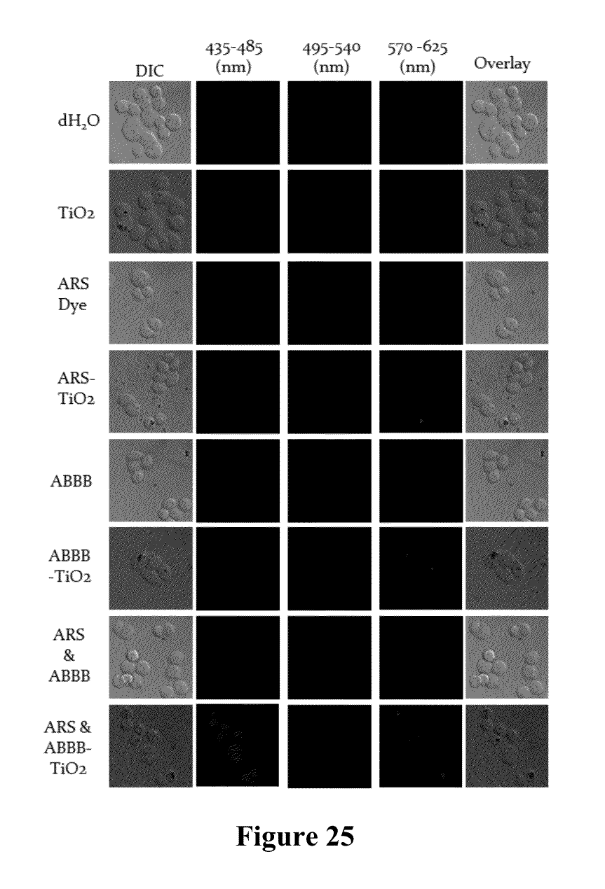

FIG. 26 shows the varying efficiencies of different dye-modified TiO₂ nanoparticles in degrading plasmid DNA. All lanes contained plasmid DNA+either: lane 1=no addition, lane 2=dye, lane 3=TiO₂ nanoparticles, lane 4=dye-TiO₂ nanoparticles, yellow=visible light exposure, white=no light exposure.

FIG. 27 shows atomic force microscope images of the degradation of plasmid DBA by dye-coated TiO₂.

FIG. 28 shows the ability of dye-coated TiO₂ nanoparticles to reduce bacterial growth on glass surface.

FIG. 29 demonstrates that increasing the duration of light exposure on cells treated with dye-modified TiO₂ nanoparticles results higher cellular damage. Blue=Hoechst 33342/DNA; Green=Emerin; Red=ABBB-TiO₂ nanoparticles.

### DETAILED DESCRIPTION OF THE INVENTION

The present invention relates to nanoconjugates and methods for destructive sorption of target biological agents. The nanoconjugates are dye-coated metal oxide nanoparticles, wherein the coating allows photoactivation of the nanoparticles through exposure to visible light. In particular, the present invention provides nanoconjugates and method for absorbing and destroying bacteria. To this end, the invention contemplates the use of finely divided nanoscale metal oxide, wherein metal oxide nanoparticles are dye-coated and do not depend upon mutagen-inducing UV light activation, but rather enables lower intensity, visible light activation.

In one embodiment, the invention provides for a multifunctional nanoconjugate comprising: a metal oxide nanoparticle; and at least one dye ligand conjugated to the metal oxide nanoparticle.

In another embodiment, the invention provides for a method of preparing a multifunctional nanoconjugate comprising the steps of: providing a metal oxide nanoparticle; providing a dye ligand; and reacting the metal oxide nanoparticle with the dye ligand, so as to attach at least one dye ligand to the metal oxide nanoparticle to form a dye-coated metal oxide nanoparticle. For example, it is envisioned that two or more dyes are used in practicing the invention. When two dyes are used, the second dye absorbs the light emission of the first dye, thus enhancing visible light absorption and effectiveness of the nanoconjugate. The suitable dyes for purpose of this embodiment include, without limitation, alizarin red s (ARS), alizarin blue black b (ABBB), mordant orange 1 (MO1), alizarin yellow gg (AYGG), N-719, resazurin sodium salt (RSS), and acid green 25 (AG25), or a mixture thereof. In some related embodiments, more than one kind of dye is bound to the nanoparticles, to enhance decontamination of the target agent.

In yet another embodiment, the invention provides a method for destructive sorption of a target agent comprising: providing a quantity of nanoconjugates, wherein the nanoconjugates comprises a metal oxide nanoparticle and at least one dye ligand conjugated to the metal oxide nanoparticle; and contacting the nanoconjugates with a target agent.

### DEFINITIONS

Before the composition and related methods are described, it is to be understood that this invention is not limited to the particular methodology, protocols, materials, and reagents described, as these may vary. The terminology used herein is for the purpose of describing particular embodiments only, and is not intended to limit the scope of the present invention which will be limited only by any later-filed non-provisional applications.

As used herein, the term “nanoconjugate” relates to core-shell metal oxide nanoparticles, which is coated with at least one dye ligand.

As used herein, the term “metal oxide nanoparticles” includes TiO₂. Other metal oxides are expected to have same or similar effect for purpose use herein, such as MgO, CaO, ZrO₂, FeO, V₂O₃, V₂O₅, Mn₂O₃, Fe₂O₃, NiO, CuO, Al₂O₃, ZnO and alike, and mixtures thereof. The nanoparticle size desired by this invention can vary widely, and essentially any particle size in the nanoparticle size range (e.g., below 1,000 nm) can be used. In some embodiments, the nanoparticles have an average crystallite size of up to about 20 nm which can covalently bond to numerous ligands, preferably from about 3-8 nm, and more preferably 6 nm. The shape of the nanoparticles may be regular (column, cube, cylinder, pillar, pyramid, rod, sphere, tube. wire etc.) or irregular/random. The shape of the nanoparticles can be controlled by adjusting the reaction dynamics and aging/ripening time.

The metal oxide nanoparticles have unique electronic properties due to their limited size and a high density of corner or edge surface sites, especially when the average crystallite size of the nanoparticles is less than 100 nm and suitably less than 20 nm.

The first one comprises the structural characteristics, namely the lattice symmetry and cell parameters. The second size-induced effect is related to the electronic properties of the oxide, namely the quantum size or confinement effects which essentially arise from the presence of discrete, atom-like electronic states. When the metal oxide particles are in the nanocrystalline regime, a large fraction of the atoms that constitute the nanoparticle are located at the surface with significantly altered electrochemical properties. For example, when the size of nanocrystalline TiO₂ becomes smaller than 20 nm, the surface Ti atoms adjust their coordination environment from hexacoordinated (octahedral) to pentacoordinated (square pyramidal). The change in coordination environment is followed by a compression of the Ti—O bond to accommodate for the curvature of the nanoparticle.

The undercoordinated defect sites on the surface of metal oxide nanoparticles are the source of novel enhanced and selective reactivity of the nanoparticle toward bidentate ligand binding, especially enediol ligands undergo unique binding at the surface, resulting in new hybrid properties of the surface-modified nanoparticle colloids, such as exceptional fine-tuning of the optical and electrochemical properties of metal oxide nanoparticles. For example, the pre-edge structure of nanocrystalline TiO₂ in the size domain of less than 20 nm shows changes in symmetry of the surface sites so that the overlap of the orbitals of the metal atoms with those of neighboring atoms changes, and hybridized sub-bands that form the conduction bands of metal oxides depart from the electronic structure of the TiO₂ bulk. Upon binding with enediol ligands to the surface sites, the asymmetry of these surface sites is removed, and the bulk structure of the conduction bands is restored.

For example, the bidentate binding with ortho hydroxyl groups of enediol ligands suggests the formation of a five-membered ring around surface Ti atoms, which is a favorable conformation of bond angles and distances for the octahedral coordination of surface Ti atoms. The dissociative chemisorption of catechol leads to a shift of optical transitions to longer wavelengths in the optical spectrum, whereas molecular absorption does not. The strong electronic coupling of enediol chelating ligands to nanocrystalline particles, which is a consequence of absorption-induced surface restructuring, also affects the light-induced charge separation. Because the optical properties of modified particles are different from the optical properties of both constituents, optical transitions that occur are the consequence of the charge transfer between the two components.

As used herein the “dye compound” or “dye ligand” used to coat TiO₂ nanoparticles are enediol ligands, which have structure R—C(OH)═C(OH)—R, wherein the atomic arrangement R—C(OH)═C(OH)—R produced by proton migration from the CH of a —CHOH group that is attached to a —CO— group to the oxygen of the —CO— group (usually induced by alkali), giving rise to doubly bonded carbon atoms (the -ene group), each bearing a —CHOH group (a diol). In one embodiment of the invention, the enediol ligand compound disclosed is alizarin red s (ARS). Other suitable dyes used to coat nanoparticles identified here include, but are not limited to, alizarin blue black b (ABBB), mordant orange 1 (MO1), alizarin yellow gg (AYGG), N-719, resazurin sodium salt (RSS), and acid green 25 (AG25), and/or mixture thereof. Table 1 lists examples of dyes of interest that interact with TiO₂ nanoparticles under suitable conditions are provided. For each dye of interest, the molecular structure, absorbance and emission for the dye and dye coated TiO₂ nanoconjugate, and molecular weight are provided. 1=data from literature; x=empirical data from the inventor; a, b, c, etc=intensity of peaks (with a being the strongest)

TABLE 1
Example of dyes of interest

| Examples of | | Visible Light | Visible Light | Molecular |
|---|---|---|---|---|
| Dyes of Interest | Structure | Absorbance(s) | Emission(s) | Wt. |
| alizarin red s alizarin red s- TiO₂ (emission in red filter) | 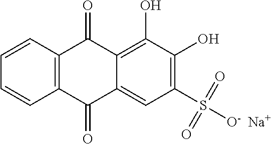 [SMILES: O=C1c2ccccc2C(=O)c2c1cc(S(=O)(=O)[O-])c(O)c2O ; [Na+]] | 420 nm (l), 250 nm (a)(x), 320 nm (b)(x), 420 nm (b)(x) altered compared to dye | 563 nm (500-750)(x) 508 nm (b)(x), 609 nm (550-750)(a)(x) | 342.26 |
| alizarin blue black b alizarin blue black b-TiO₂ (emission in green & red filter) | 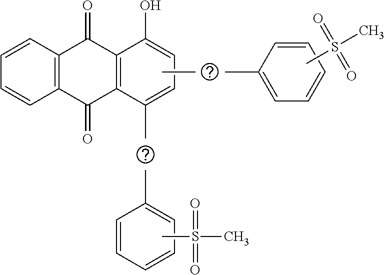 | 548 nm (l), 240 nm (a)(x), 290 nm (a)(x), 540 nm (450 nm- 650 nm)(b)(x) altered compared to dye | 540 nm (510-550)(b)(x) 600 nm (580-620)(a)(x) 530 nm (500-555)(a)(x) 655 nm (625-725)(a)(x) | 610.52 |
| mordant orange 1 mordant orange 1-TiO₂ (emission in red filter) green? | 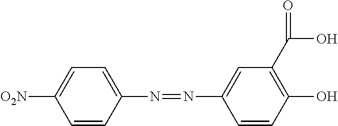 [SMILES: O=C(O)c1cc(N=Nc2ccc([N+](=O)[O-])cc2)ccc1O] | 385 nm (l), 270 nm (b)(x) 375 nm (310-450)(a)(x) altered compared to dye | minor (x) 565 nm (500-700)(x) | 287.23 |
| alizarin yellow GG alizarin yellow GG-TiO₂ (emission in green & red filter) | 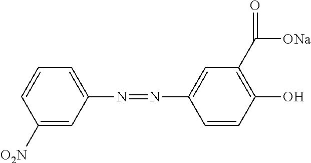 | 362 nm (l), 250 nm (a)(x) 350 nm (300-400)(a)(x) altered compared to dye | minor (x) 546 nm (500-650)(a)(x) | 309.21 |
| N-719 N-719-TiO₂ (emission in red filter) | 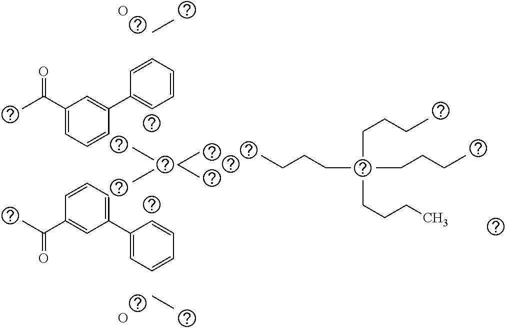 | 313 nm (l), 310 nm (x) 393 nm (l), 375 nm (x) 534 nm (l), 520 nm (x) altered compared to dye | 545 nm, 560 nm, 580 nm, 620 nm, 640 nm (x) 615 nm (525-725)(x) | 1188.55 |
| Resazurin sodium salt Resazurin sodium salt-TiO₂ | 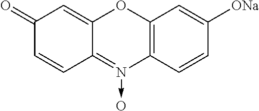 | 380 nm (b)(l) 598 nm (a)(l) flatline (x) flatline (x) | 585 nm (550-700)(a)(x) 539 nm, 550 nm, 590 nm, 640 nm (x) | 251.17 |

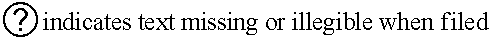

As used herein, the term “electrostatic binding interaction” refers to any interaction occurring between charged components, molecules or ions, due to attractive forces when components of opposite electric charge are attracted to each other. Examples include, but are not limited to: ionic interactions, interactions between an ion and a dipole (ion and polar molecule), interactions between two dipoles (partial charges of polar molecules), hydrogen bonds and London dispersion bonds (induced dipoles of polarizable molecules). Thus, for example, “ionic interaction” or “electrostatic interaction” refers to the attraction between a first, positively charged molecule and a second, negatively charged molecule. Ionic or electrostatic interactions include, for example, the attraction between a negatively charged bioactive agent.

As used herein, the term “covalent binding interaction” is art-recognized and refers to any interaction between two atoms where electrons are attracted to both nuclei of the two atoms, and the net effect of increased electron density between the nuclei counterbalances the internuclear repulsion. The term covalent bond includes coordinate bonds when the bond is with a metal ion.

As used herein, “visible light” activation of dye-coated metal oxide nanoparticles, leads to degradation of neighboring biological agents through production of reactive oxygen species. The term “visible light activation” will be understood to mean that the photocatalyst is activated by exposure to light in the visible region. The terms “visible region” or “visible light” refer to electromagnetic radiation having a wavelength in the range of 400 nm to 700 nm. The same level of damage to biological agents can also be achieved through exposure of dye-coated nanoparticles to UV light. The terms “UV light” or “ultraviolet region” mean electromagnetic energy having a wavelength in the range of 10 nm to less than 400 nm. Consequently, visible light activation of dye-coated metal oxide nanoparticles is valued over UV light activation in applications where protection of neighboring biological agents is of high importance.

As used herein, the term “agent” refers to a composition that possesses a biologically or chemically relevant activity or property. Relevant activities are activities associated with biological or chemical reactions or events or that allows the detection, monitoring, or characterization of biological reactions or events. Suitable agents include, for example, bacteria, viruses, toxins, fungi, rickettsiae, chlamydia cells, or a mixture thereof.

As used herein, the term “bacteria” (singular: bacterium) refers to a large domain of prokaryotic microorganisms, suitably Gram-negative and Gram-positive. Typically a few micrometers in length, bacteria have a wide range of shapes, ranging from spheres to rods and spirals. Bacteria herein include any existence of bacteria such as surface dwelling bacteria, and the bacteria growing in soil, acidic hot springs, radioactive waste, water, and deep in the Earth's crust, as well as in organic matter and the live bodies of plants and animals, providing examples of mutualism in the digestive tracts of humans, termites and cockroaches.

Utilizing the nanoconjugates in accordance with the methods of the invention is particularly useful for destructively absorbing biological agents such as bacteria (e.g., gram positive bacteria like B. subtilis, B. globigii and B. cereus or gram negative bacteria like E. coli, and E. Herbicola). In this embodiment, it is envisioned that the nanoconjugates degrade nucleic acids that may transferred between bacteria. In one example, activation of Alizarin red s-coated TiO₂ nanoparticles results in transfer of electrons to Ti sites and deposition of electropositive holes on Alizarin red. Additionally, activation of alizarin red s/TiO₂ dispersions by visible light resulted in the production of both superoxide and hydroxyl radical. Other surface coatings have been investigated which do not modify the photoreactivity of TiO₂ nanoparticles through altering the band gap of the nanoconjugate, but rather affect the post-excitation events. This can be seen most visibly when the biological target is DNA. TiO₂ surface sites have an affinity for the phosphate backbone of DNA, so direct injection of electropositive holes from activated bare TiO₂ nanoparticles to the DNA backbone is possible. At the same time, activation of these bare TiO₂ nanoparticles may result in the escape of electropositive holes into the surrounding aqueous environment and result in the localized production of reactive oxygen species. Reactive oxygen species have been shown to possess short half lives and travel short distances, so localized damage to DNA can result in either of the described post excitation events. Coating nanoparticles with chemicals such as glycidyl isopropyl ether (GIE) relieves this interaction between the nanoparticle and phosphate backbone, which has two important implications for post excitation events. First, full GIE coating of TiO₂ nanoparticles covers surface Ti sites and relieves the interaction of the nanoparticle with the DNA phosphate backbone, which eliminates direct injection of electropositive holes into the DNA. Second, full GIE coating of TiO₂ nanoparticles insulates electropositive holes from the surrounding aqueous environment. Both of these changes result in the reduction of DNA damage upon photoactivation of the nanoconjugate. The addition of nucleic acids to the nanoparticle surface restores nanoparticle/DNA interaction in a sequence specific manner and may once again allow for the direction injection of electropositive holes from the nanoparticle into the DNA molecule.

The nanoconjugates are also useful for absorbing toxins such as Aflatoxins, Botulinum toxins, Clostridium perfringens toxins, Conotoxins, Ricins, Saxitoxins, Shiga toxins, Staphylococcus aureus toxins, Tetrodotoxins, Verotoxins, Microcystins (Cyanginosin), Abrins, Cholera toxins, Tetanus toxins, Trichothecene mycotoxins, Modeccins, Volkensins, Viscum Album Lectin 1, Streptococcal toxins (e.g., erythrogenic toxin and streptolysins), Pseudomonas A toxins, Diphtheria toxins, Listeria monocytogenes toxins, Bacillus anthracis toxic complexes, Francisella tularensis toxins, whooping cough pertussis toxins, Yersinia pestis toxic complexes, Yersinia enterocolytica enterotoxins, and Pasteurella toxins. In another embodiment, the methods of the invention provide for the destructive absorption of hydrocarbons, halogenated hydrocarbons, both chlorinated and non-chlorinated. Such hydrocarbon compounds include but are not limited to 2-chloroethyl ethyl sulfide (2-CEES), diethyl-4-nitrophenylphosphate (paraoxon), and dimethylmethylphosphonate (DMMP).

The nanoconjugates of the invention can also be used to neutralize or decontaminate potent chemical agents such as, for example: blister or vesicant agents such as mustard agents; nerve agents such as methylphosphonothiolate (VX); lung damaging or choking agents such as phosgene (CG); cyanogen agents such as hydrogen cyanide; incapacitants such as 3-quinuclidinyl benzilate; riot control agents such as CS (malonitrile); smokes such as zinc chloride smokes; and some herbicides such as 2,4-D (2,4-dichlorophenoxy acetic acid). All of the above agents, as well as numerous other biological and chemical agents, pose a significant risk to private citizens as well as to military personnel.

The following examples set forth preferred nanoconjugates and methods in accordance with the invention. It is to be understood, however, that these examples are provided by way of illustration and nothing therein should be taken as a limitation upon the overall scope of the invention.

### Example 1

### Core Nanoparticle Preparation

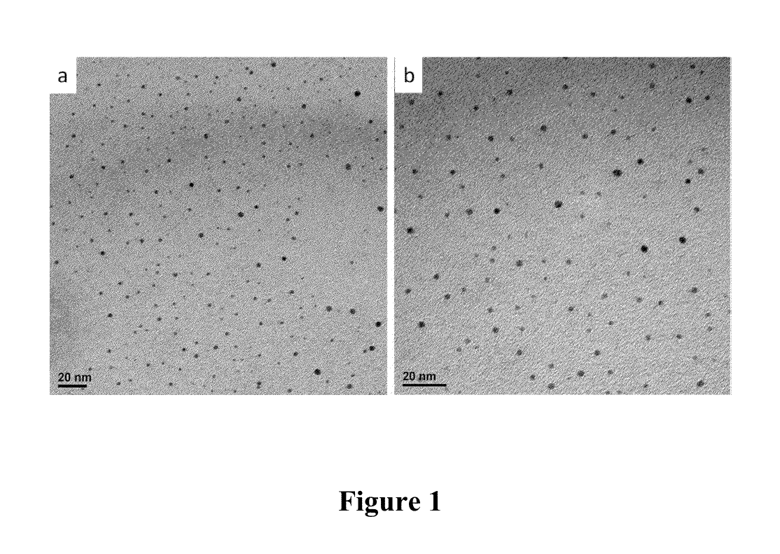

For the synthesis of 6 nm TiO₂ nanoparticles, TiCl₄ was used as the reaction agent, and cetyltrimethyl ammonium bromide (CTAB) was used as the dispersant (see, e.g., Aiguo Wu, et al., Nano. 2008, 3 (1): 27-36, hereby incorporated by reference in its entirety). All agents were purchased from Guoyao Ltd (China) as analytical pure grade and deionized water was used as solvent. Before the experiment, 0.1 M TiCl₄ in 20% HCl solution was first prepared and stored at −20° C. The synthesis of TiO₂ nanoparticles was carried out using a magnetic stirrer and the reaction temperature was about 4° C., which was controlled in an ice bath. First, 10 mL of 0.1 M TiCl₄ solution was gradually dropped into 200 mL of deionized water under vigorous stirring, and the reaction was maintained for approximately 4 h. Then 10 mL of 0.5 mM CTAB was dropped into the solution, and the solution was continuously stirred magnetically for approximately 1 h. Finally, the product was purified by dialyzing the TiO₂ colloids in deionized water five times, and the powder of TiO₂ nanoparticles was prepared by freezing out using a freeze drier. The morphology of TiO₂ nanoparticles was characterized with a Tecnai F20 (FEI Company, Hillsboro, Oreg., USA) transmission electron microscope (TEM). The TEM sample was prepared by dropping the TiO₂ nanoparticles dispersed in water onto a carbon-coated copper grid. FIG. 1 shows TEM images of TiO₂ nanoparticles under different magnifications. It can be seen that the TiO₂ nanoparticles were well dispersible and of single crystal size of approximately 6 nm. TiO₂ nanoparticles are also commercially available, such as from SIGMA.

### Example 2

### Assessing Dye Coating of Nanoparticles

Six nanometer TiO₂ nanoparticles were synthesized and characterized through the methods described above. The interaction of two dyes, ARS (Sigma, St. Louis, Mo., USA) and orange G (Sigma), with TiO₂ nanoparticles was investigated through four different methods: sedimentation, spectral light absorbance, spectral fluorescence emission, and polyacrylamide gel electrophoresis. Sedimentation assays were performed by incubating each respective dye and TiO₂ nanoparticles, centrifuging samples at 0.2 g for 3 min, then imaging with a Canon Powershot 7.1 Megapixel A620 digital camera. Shifts in spectral light absorbance and spectral fluorescence emission between dyes and dye-coated TiO₂ nanoparticle samples were measured with a NanoDrop 2000 UV-Vis spectrophotometer as described previously [7] and NanoDrop 3300 Fluorospectrometer, respectively (Thermo Fisher Scientific, Waltham, Mass., USA). Stability between dye-TiO₂ nanoconjugates was assessed by running samples through a 16% polyacrylamide gel for 2 has described previously [5].

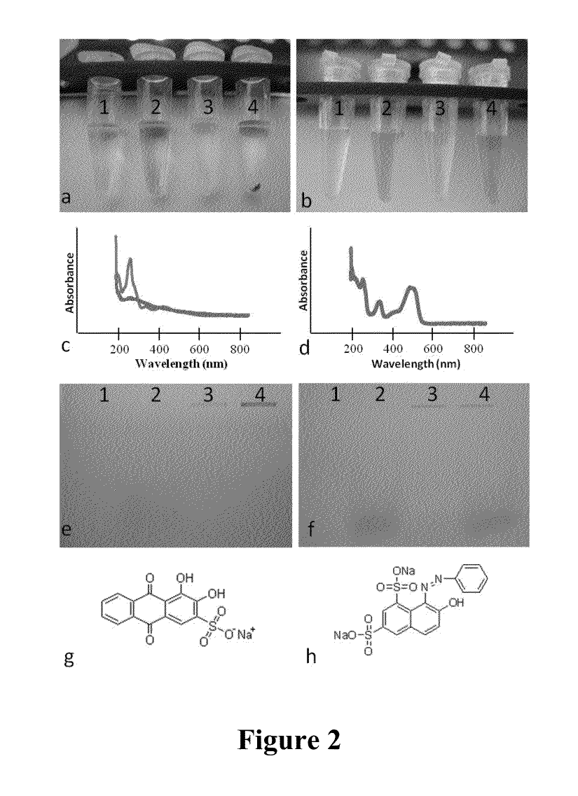

To demonstrate the successful coating of TiO₂ nanoparticles with the fluorescent dye, ARS, we utilized established techniques such as sedimentation, spectrophotometry, and polyacrylamide gel electrophoresis [5,7] and also incorporated an additional assay to measure variations in fluorescence spectral emission of samples. In the sedimentation assay, test tubes containing either (1) dH₂O, (2) ARS, (3) TiO₂ nanoparticles, or (4) ARS-coated TiO₂ nanoparticles were prepared. Upon centrifugation of these samples at 0.2 g, TiO₂ nanoparticles sedimented out of solution and formed a white pellet on the test tube bottom (FIG. 2a, tube 3), whereas free ARS dye did not sediment under the same conditions (FIG. 2a, tube 2). In the tube containing ARS dye and TiO₂ nanoparticles, a red pellet was observed at the bottom of the test tube, indicating successful conjugation between ARS and TiO₂ nanoparticles (FIG. 2a, tube 4). In contrast, when an alternative dye, orange G, was used under the same conditions as a negative control, the pellet in tube 4 containing dye and TiO₂ nanoparticles remained white and the dye remained in the supernatant, indicating no interaction between orange G and TiO₂ nanoparticles (FIG. 2b). When measuring spectral absorbance, ARS-coated TiO₂ nanoparticles demonstrated a red shift in spectral absorbance compared to their ARS counterparts (FIG. 2c), indicative of a dye-nanoparticle interaction [7]. Under the same conditions, no shift in absorbance was witnessed for orange G and TiO₂ counterparts (FIG. 2d).

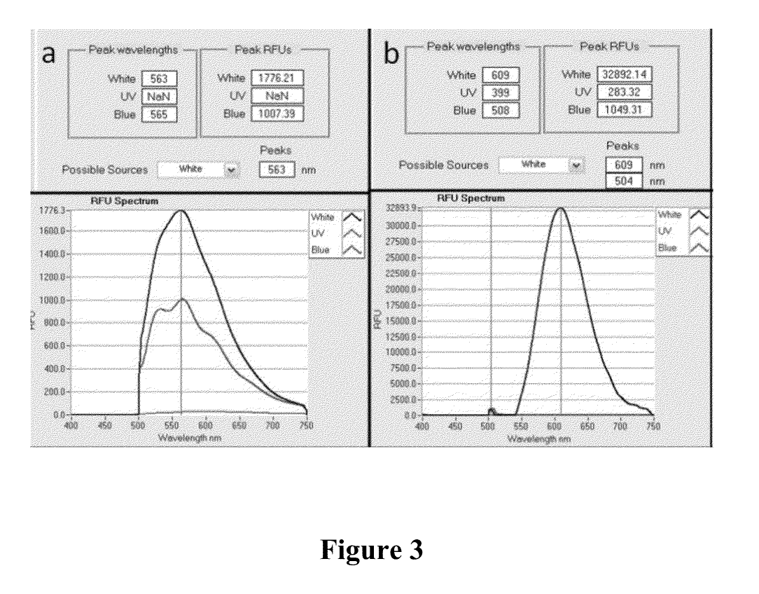

In the gel electrophoresis assay, we utilized the fact that TiO₂ nanoparticles do not enter into a polyacrylamide gel during standard electrophoresis [2], while selected dyes do enter into such a gel (5) to assess dye-TiO₂ nanoparticle interactions. The same samples described above were used. Upon polyacrylamide gel electrophoresis of samples, ARS (FIG. 2e, lane 2) migrated through the gel, while TiO₂ nanoparticles (FIG. 2e, lane 3) and ARS-coated TiO₂ nanoparticles remained trapped in the wells of the gel and a distinct red band was visible (FIG. 2e, lane 4). Under the same conditions, orange G did not remain associated with TiO₂ nanoparticles in the gel well, but rather migrated into the gel (FIG. 2f, lane 4). Thus, in the case of the orange G, both lanes 3 and 4 possessed a white band in the well of the gel. This electrophoresis data further supported the ability of ARS dye to successfully coat TiO₂ nanoparticles. These results supported the findings in the literature that enediol bidentate ligands such as ARS covalently interact with TiO₂ nanoparticles of less than 20 nm in diameter, whereas similar ring structured molecules lacking these functional groups (such as orange G) do not interact [1] (FIGS. 3g-3h). ARS and orange G dyes were selected for these reasons.

Further support for interaction between ARS and TiO₂ nanoparticles was gained by viewing differences in the fluorescence emissions between ARS and ARS-coated TiO₂ nanoconjugates that were excited by either UV, blue, or visible light. ARS dye was excitable by both blue and visible light and exhibited an emission maximum between 563-565 nm (FIG. 3a). On the other hand, ARS-coated TiO₂ nanoconjugates were not comparably excited by either UV or blue light and were only excitable by white light, with an emission maximum of 609 nm (FIG. 3b). Compared to ARS, the lack of excitation of ARS nanoconjugates with blue light and the red shift in fluorescence emission when excited with white light is supportive of ARS-TiO₂ interaction. It is also consistent with the red shift in absorbance witnessed when comparing ARS with ARS-coated TiO₂ nanoparticles (FIGS. 2c, 2d). The fluorescence emission data also proved valuable in the confocal microscopy studies described later.

### Example 3

### Visible Light Activated ARS-Coated TiO₂ Nanoparticles Degrade Plasmid DNA

The effect of visible light activated ARS-coated TiO₂ nanoparticles was assessed by illuminating plasmid containing samples with a Fiber-Lite MI-150High Intensity Fiber Optic EKE 150 W21VHalogen Light Illuminator (Dolan-Jenner Industries, Boxborough, Mass., USA) for 10 min. The effect of UV light on activated ARS-coated TiO₂ nanoparticles was assessed by illuminating plasmid containing samples with a 390 nm 13 W UV light source (Bayco, Wylie, Tex., USA). All samples were then run on a 1.25% agarose gel at 60V for 4 h, stained with GelStar (Lonza, Mapleton, Ill., USA), and imaged on a Kodak Gel Logic 2200 Imaging System (Kodak, Rochester, N.Y., USA).

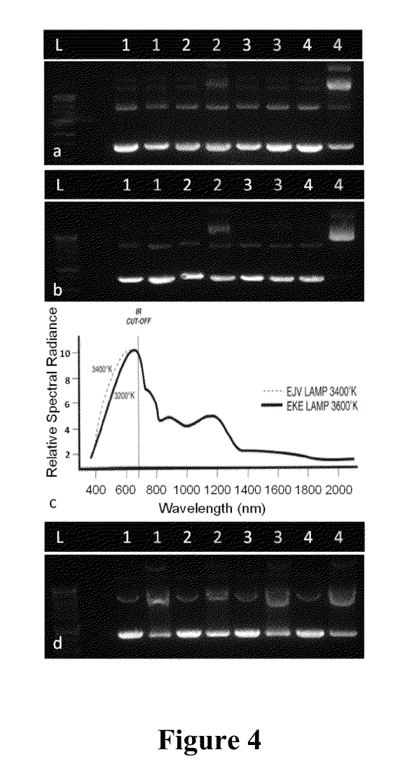

As stated previously, it has been shown that dyes in general and ARS/TiO₂ dispersions in particular are capable of releasing reactive oxygen species upon photoactivation by visible light [12,13]. Additionally, the DNA phosphate backbone has affinity for TiO_{2 [}14]. Considering these factors, we sought to determine the effect of visible light activated ARS-coated TiO₂ nanoparticles on plasmid DNA integrity using a standard agarose gel electrophoresis technique developed by others. According to this assay, nicked (single-stranded DNA break), linear (double-stranded DNA break), and supercoiled (undamaged) plasmid DNA can be distinguished on an agarose gel by viewing differences in mobility (with the nicked plasmid DNA migrating at the slowest rate and supercoiled plasmid DNA migrating at the fastest rate) [13,15]. Samples were prepared that contained plasmid DNA and either (1) dH₂O, (2) ARS, (3) TiO₂ nanoparticles, or (4) ARS-coated TiO₂ nanoparticles. Half of each of the four samples was exposed for 10 min to either no light or visible light from an EKE 150 W 21V halogen bulb, and all samples were then loaded on a 1.25% agarose gel and electrophoresis was run for 5 h at 50 V (FIG. 4a). All samples contained various configurations of plasmid DNA and the major conformation was supercoiled in form, with the following exception.

When plasmid DNA was exposed to visible light activated ARS-coated TiO₂ nanoparticles (FIG. 4a, yellow lane 4), an increase in nicked (single-stranded break) plasmid DNA was observed accompanied by a respective decrease in supercoiled (undamaged) plasmid DNA. Such an increase in nicked plasmid DNA was not seen in samples containing dark exposed ARS-coated TiO₂ nanoparticles or any other samples, with the exception of a slight expected increase in nicked plasmid DNA in visible light exposed samples containing ARS (FIG. 4a, yellow lane 2). This effect was time dependent as a further increase in nicked plasmid was evident upon exposure to ARS-coated TiO₂ nanoparticles under the same light source for 20 min (FIG. 4b, yellow lane 4). This electrophoresis data demonstrated the ability of ARS-coated TiO₂ nanoparticles to induce strand breakage in DNA upon activation by visible light. The relative spectral radiance for the quartz-halogen bulb used in this study is presented (FIG. 4c). For comparison, the experiment presented in FIG. 4a was repeated substituting an UV light source in place of the visible light source. An exposure of UV was selected that resulted in the same level of plasmid nicking achieved previously (compare FIG. 4d, yellow lane 4 versus FIG. 4a, yellow lane 4 and FIG. 4d, yellow lane 2 versus FIG. 4a, yellow lane 2). However, when plasmid samples were exposed to UV light in the presence of bare TiO₂ nanoparticles, a similar level of plasmid nicking was detected (FIG. 4d, yellow lane 3). This was expected because TiO₂ nanoparticles are known to be activated by such UV light sources [1,16,17]. Such activation of bare TiO₂ nanoparticles was not witnessed when samples were exposed to visible light (FIG. 4a, yellow lane 3). Upon exposure to UV light, samples containing solely plasmid DNA exhibited moderate plasmid nicking (FIG. 4d, yellow lane 1) while no such plasmid nicking was detected in solely plasmid samples exposed to visible light) FIG. 4a, yellow lane 1).

### Example 4

### Cell Culture, Fixing and Staining, and Confocal Microscopy

HeLa cells were grown on #1 glass coverslips to approximately 20% confluence and then exposed to ARS-coated TiO₂ nanoparticles or appropriate controls overnight. Respective samples were either exposed to no light or light with a Fiber-Lite MI-150 High Intensity Fiber Optic 150 W Halogen Light Illuminator for 10 min. All samples were fixed in 3.6% formaldehyde (Fisher Scientific, Waltham, Mass., USA) and permeabilized in 0.2% Triton-100× (Fisher Scientific) for 10 min. Cells were then stained with either a mouse monoclonal to emerin primary antibody (Abcam, Cambridge, Mass., USA) followed by an Alexa488 goat anti-mouse IgG (H+L) secondary antibody (Invitrogen, Grand Island, N.Y., USA) or a chicken polyclonal to lamin B1 primary antibody (Abcam) followed by an Alexa488 goat anti-chicken IgG (H+L) secondary antibody (Invitrogen). All samples were then stained with Hoechst 33342 (Sigma) and coverslips were mounted in P-phenylenediamine containing mounting media. Samples were imaged on an Olympus IX81-UCB Spinning Disc Confocal Microscope (Olympus, Center Valley, Pa., USA) using a 100 W mercury burner (Ushio, Tokyo, Japan), Brightline filters for DAPI, FITC, and TEXAS RED (Semrock, Rochester, N.Y., USA), and an ORCA-ER-1394 high-resolution digital camera (Hamamatsu, Japan). All images are presented as 1 mm optical slice fluorescence overlays in either two or three dimensions.

### Example 5

### Alterations in Integrity and Distribution of Nuclear Membrane Associated Proteins Resulting from Visible Light Activated ARS-Coated Nanoparticles

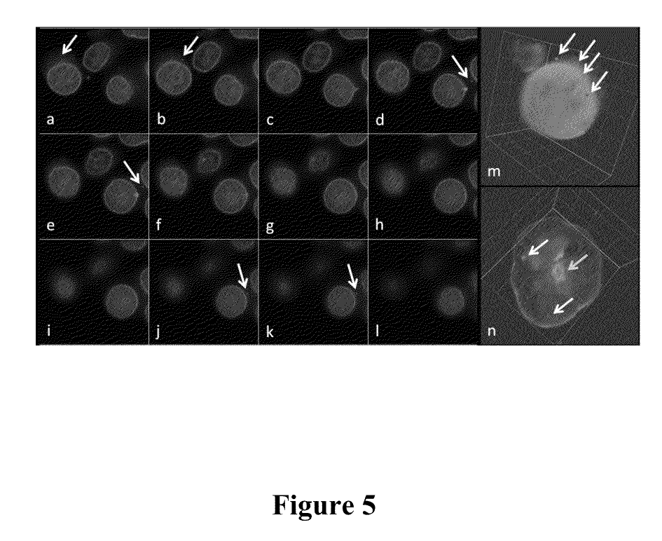

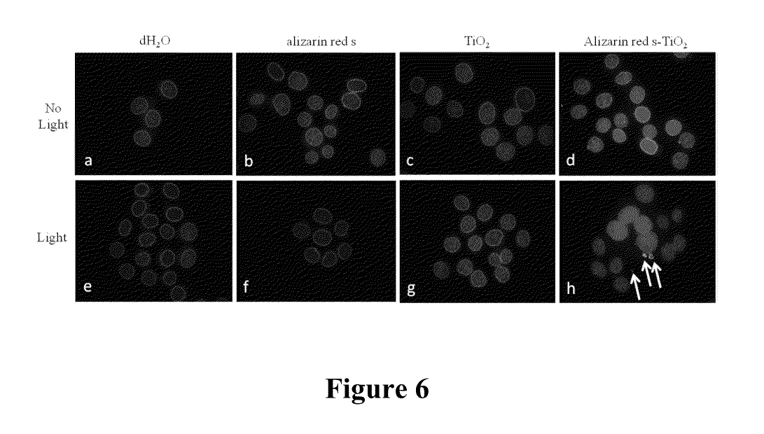

Perinuclear localization of ARS-TiO₂ nanoconjugates was previously observed in cancer cells via fluorescence confocal microscopy by comparing nanoconjugate localization to DNA staining within the nucleus and also via X-ray fluorescence [7,8]. We expanded upon these studies in our current investigation by viewing the spatial relation of ARS-TiO₂ nanoparticles to two nuclear membrane associated proteins, emerin and lamin B1 (FIG. 5), and determining the effect of visible light activated ARS-coated TiO₂ nanoparticles on the integrity and distribution on these membrane associated proteins via fluorescence confocal microscopy (FIGS. 6-8). Perinuclear localization of ARS-coated TiO₂ nanoparticles was evident in viewing a Z-stack series of HeLa cells (1 mm optical slices) and comparing the relation of ARS-coated TiO₂ nanoparticles to emerin (green)(FIGS. 5a-5l). Localization of ARS-coated TiO₂ nanoparticles is emphasized by white arrows. Furthermore, 3D reconstructions of 1 mm optical slices taken through individual HeLa cells also supported perinuclear localization (FIGS. 5m, 5n). In addition to dye-coated nanoparticles exhibiting standard perinuclear localization, some others interacted with HeLa cells in a unique manner, creating a donut effect with emerin tunneling through the center of the HeLa cell and encompassing the ARS-coated TiO₂ nanoparticles (FIG. 5n, central yellow arrow).

Next, we sought to determine the effect of visible light excitation of ARS-coated TiO₂ nanoparticles on emerin integrity and distribution. HeLa cells were exposed to either dH₂O, ARS, TiO₂ nanoparticles, or ARS-coated TiO₂ nanoparticles and either light or no light conditions (FIG. 6). Large scale alterations in emerin integrity and distribution were detected in HeLa cells exposed to ARS-coated TiO₂ nanoparticles and 150 W halogen white light for 10 min (FIG. 6h), as nuclear rim staining of emerin was decreased and more punctuated (white arrows), compared to HeLa cells exposed to ARS-coated TiO₂ nanoparticles under dark conditions (FIG. 6d). Some DNA condensation was observed in cells exposed to ARS-TiO₂ nanoparticles independent of light exposure (FIGS. 6d, 6h), and some enlarged nuclei were also observed when ARS-coated TiO₂ nanoparticles were exposed to visible light. HeLa cells exposed to dH₂O (FIGS. 6a, 6e), ARS (FIGS. 6b, 6f), and TiO₂ nanoparticles (FIGS. 6c, 6g) exhibited normal emerin integrity and distribution regardless of light treatment.

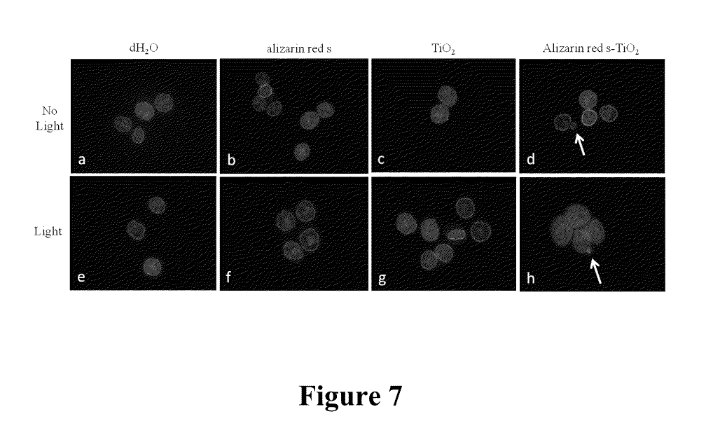

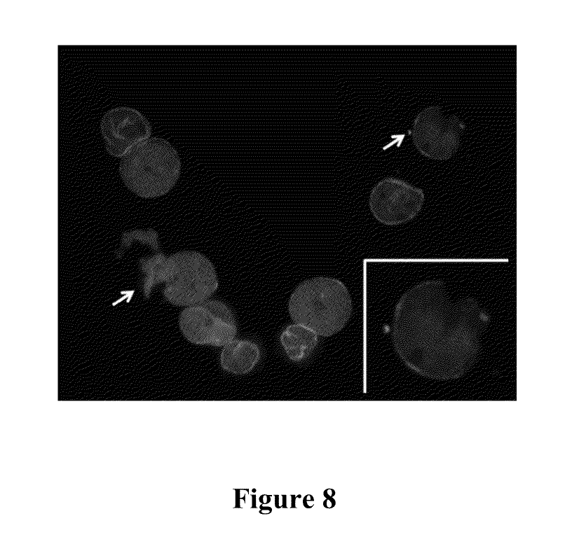

The effect of visible light excitation of ARS-coated TiO₂ nanoparticles on the integrity and distribution of a second membrane associated protein, lamin B1, was also investigated (FIG. 7). HeLa cells were exposed to the same conditions as in the previous experiment. Alterations in lamin B1 integrity and distribution were detected in HeLa cells exposed to ARS-coated TiO₂ nanoparticles and visible light (FIG. 7h), as nuclear rim staining was decreased and more punctuated when compared to HeLa cells exposed to ARS-coated TiO₂ nanoparticles, but no white light (FIG. 7d). HeLa cells exposed to dH₂O (FIGS. 7a, 7e), ARS (FIGS. 7b, 7f), and TiO₂ nanoparticles (FIGS. 7c, 7g) demonstrated normal lamin B1 integrity and distribution. Additionally, some cells exposed to ARS-coated TiO₂ nanoparticles and visible light exhibited nuclei with DNA “leaking” outside of the nuclear membrane, and other cells possessed a completely fragmented lamin B1 lamina under these conditions (FIG. 8, white arrows).

### Example 6

### Bacterial Assays Using ARS-Coated TiO₂ Nanoparticles

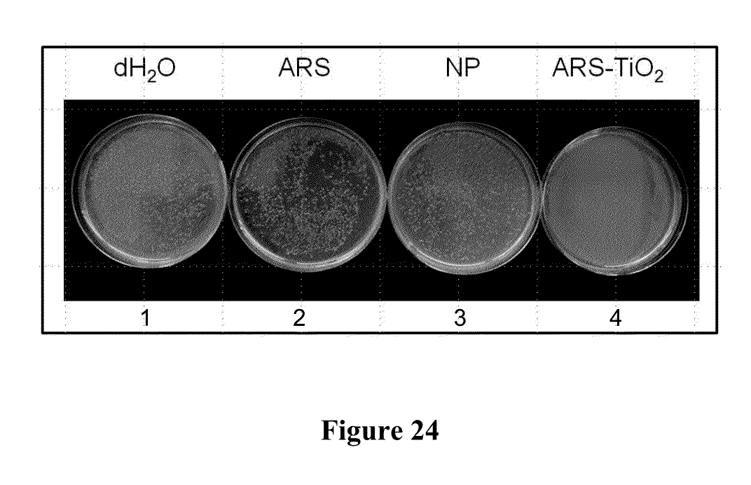

When using dye-coated TiO₂ nanoconjugates to inflict damage on bacteria, the dye alizarin red s was used (FIG. 24). The following protocol was used: a bacterial culture of kanamycin-resistant E. coli was grown overnight at 37° C. at 250 rpm and then stored at 4° C. for later use in the experiment. Aliquots of the starter bacterial culture were then incubated with either (1) dH₂O, (2) alizarin red s, (3) 6 nm TiO₂ nanoparticles, or (4) alizarin red s-coated-6 nm TiO₂ nanoconjugates for 10 minutes. All samples were then exposed to a 150 W halogen bulb for 10 minutes and plated on kanamycin-containing LB agar plates, incubated overnight at 37° C., and photographed with a digital camera. While bacterial colonies are witnessed on plates 1-3, no bacterial growth is evident in the plate incubated with alizarin red s-coated-6 nm TiO₂ nanoconjugates, suggesting that release of reactive oxygen species upon visible light photoactivation of dye-coated TiO₂ nanoparticles results in bacteria death.

### Example 7

### Efficiencies of Different Dye-Modified TiO₂ Nanoparticles in Degrading Plasmid DNA

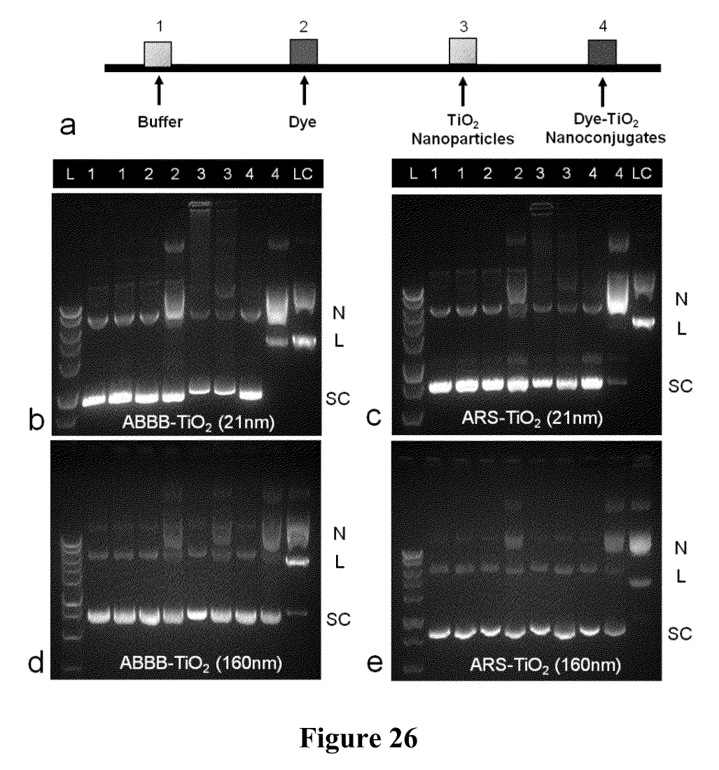

This Example expands upon previous Example 6 by showing two important findings that support our claims (FIG. 26). First, it compares the varying efficiencies of different dye-modified TiO₂ nanoparticles in degrading plasmid DNA (plasmid DNA often conveys antibiotic resistance to bacteria). Second, as shown in FIG. 26, the efficiencies of plasmid degradation are lowered substantially which dye coating are applied to larger aggregates of TiO₂ (emphasizing that the dye-coating must be applied to a “nano” size TiO₂ particle).

Specifically, as shown in FIG. 2(a), a schematic of the different samples used in this assay is presented. As shown in FIG. 26(b), increased nicking and linearization of plasmid DNA was evident when 21 nm alizarin blue black B (ABBB)-modified TiO₂ nanoparticles were exposed to visible light for 10 minutes (lane 4, yellow) compared to no light (lane 4, white), and this increase in nicking was greater than when ABBB was exposed to visible light (lane 2, yellow). As shown in FIG. 26(c), reduced nicking of plasmid DNA was evident when 21 nm alizarin red s (ARS)-modified TiO₂ nanoparticles were exposed to visible light for 10 minutes compared to their ABBB counterparts. The increase in plasmid nicking witnessed in the presence of visible light activated ARS-modified nanoparticles was greater than when ARS was exposed to visible light (lane 2, yellow). As shown in FIG. 26(d,e), when the experiment is repeated with 160 nm ABBB-TiO₂ and ARS-TiO₂ nanoparticles, the previously observed differences in plasmid cleavage between visible light activated dye (lane 2, yellow) and dye-TiO₂ nanoparticles (lane 4, yellow) is no longer evident.

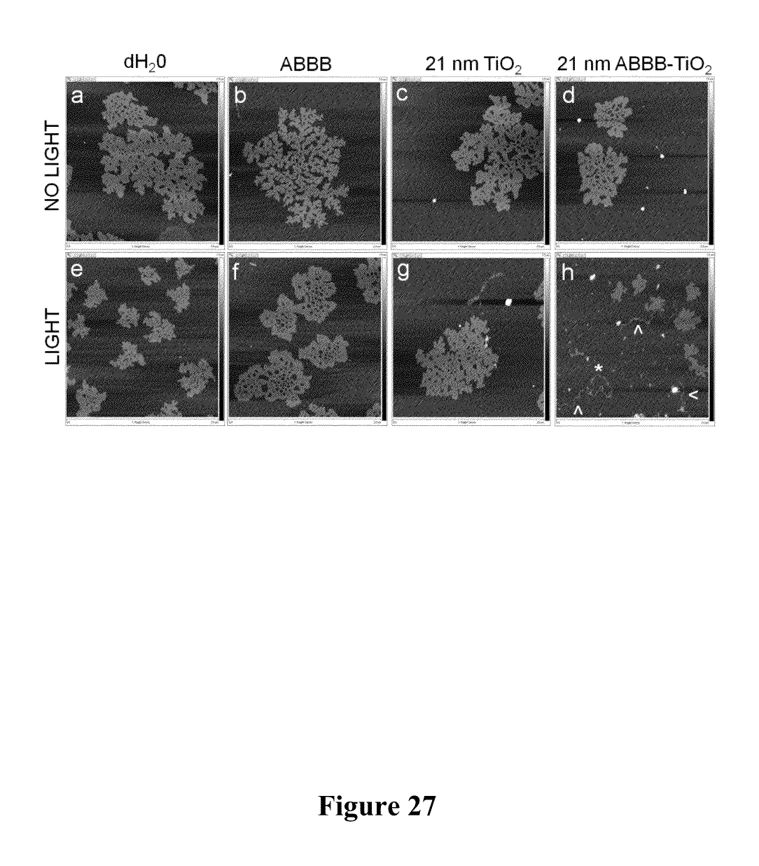

The results above are further confirmed by atomic force microscope images (FIG. 27). The images visually show the degradation of plasmid DNA (from bacteria) by dye-coated TiO₂ nanoparticles. Representative sample images of plasmid DNA on freshly cleaved mica are presented in FIG. 27(a-h) by using Peakforce Tapping Mode on a Dimension-Icon Atomic Force Microscope. Each image has the dimensions: 2.0 μm length×2.0 μm width; 7.5 nm maximum height (white). All samples contain plasmid DNA plus (a,e) water, (b,f) ABBB, (c,g) 21 nm TiO₂ nanoparticles, (d, h) 21 nm ABBB-TiO₂ nanoparticles. Samples (a-d) were kept under dark conditions, whereas samples (e-h) were exposed to a 150 W halogen bulb for 10 minutes).

### Example 8

### Ability of Dye-Modified TiO₂ Nanoparticles to Reduce Bacterial Growth

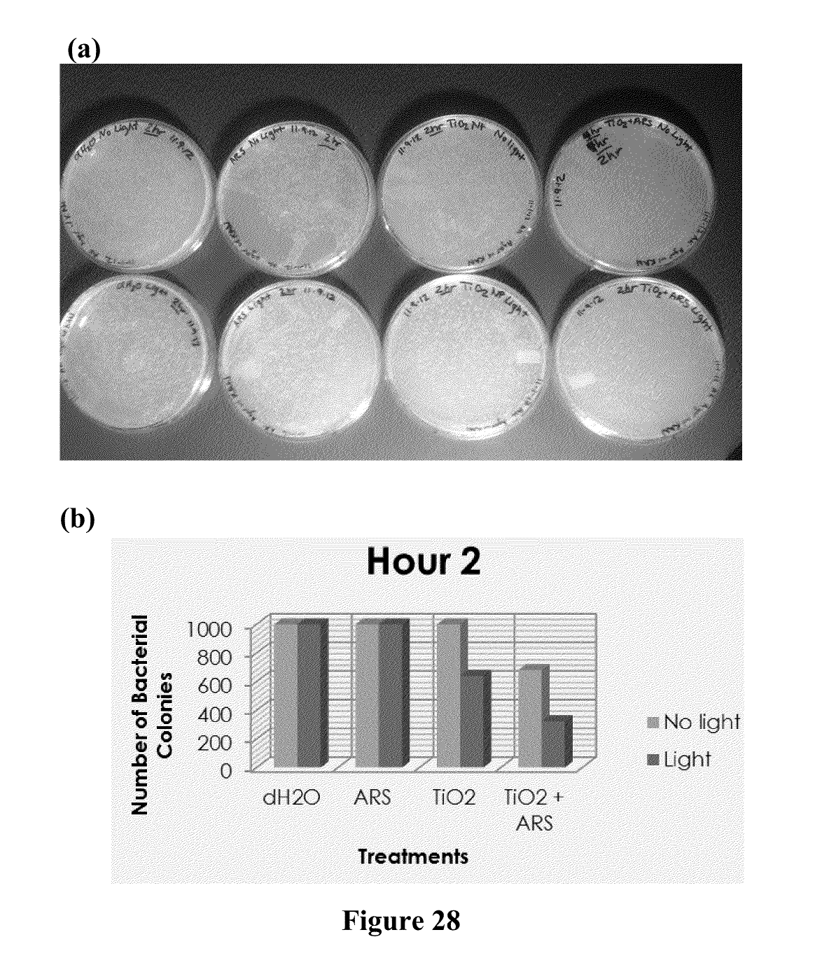

In this Example, we tested the ability of dye-modified TiO₂ nanoparticles to reduce bacterial growth on glass surfaces (FIG. 28). In the experiment, 5 μM dye-modified TiO₂ nanoparticles (or indicated controls) were applied to a glass surface an allowed to dry for 30 minutes. E. coli bacterial suspensions were applied to each glass surface on top of the treated area. All samples were then exposed to a 750 W halogen bulb or dark conditions for 2 hours. After this time, the bacteria were resuspended in liquid broth, plated on agar plates, and allowed grow for 24 hours. The number of bacterial colonies were counted in FIG. 28(b). It clearly showed that the bacterial growth was significantly reduced on the plate containing ARS-coated TiO₂ nanoparticles.

### Example 9

### The Duration of Light Exposure on Cells Treated with Dye-Modified TiO₂ Nanoparticles

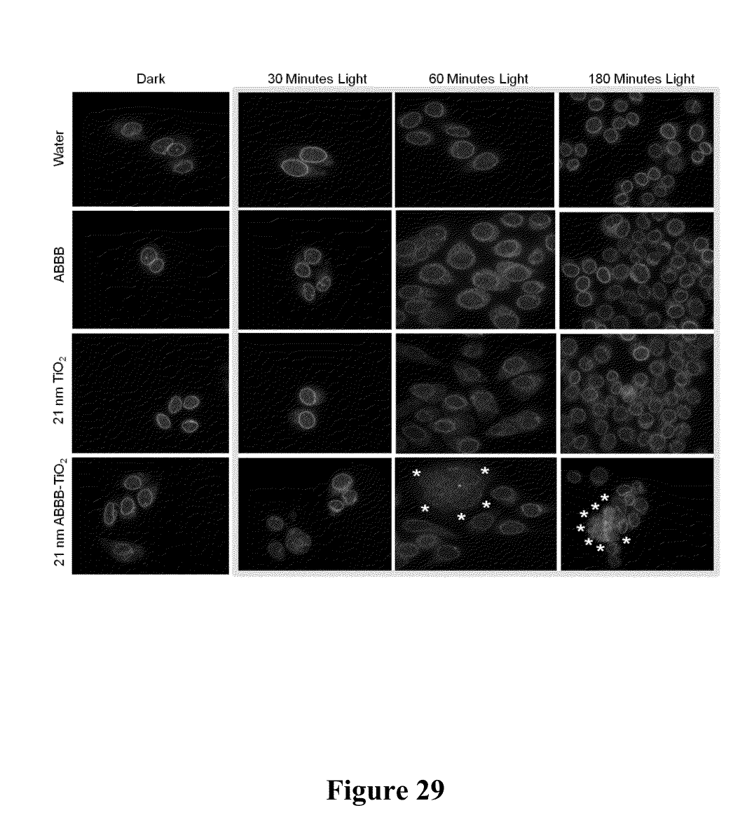

In this Example, we tested the duration of light exposure on cells treated with dye-modified TiO2 nanoparticles. As shown in FIG. 29, HeLa cells were exposed to water, ABBB, 21 nm TiO₂ nanoparticles, or 21 nm ABBB-TiO₂ nanoparticles and either no light or 750 W halogen visible light for 30, 60, or 180 minutes (yellow box). Cells were fixed in 4% formaldehyde 24 hours post exposure and 1 μm slices fluorescence confocal images are presented. Under this duration of light activation, no detectable cellular responses are visualized under any of the treatments exposed to dark or 30 minutes of visible light. Increased nuclear condensation, alterations in emerin integrity, and cellular aggregation (*) are visualized some cells exposed to ABBB-TiO₂ nanoparticles and increased durations of visible light (60 and 180 minutes). The cellular response is heterogeneous. The study demonstrates that increasing the duration of light exposure on cells treated with dye-modified TiO₂ nanoparticles results higher cellular damage.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, and “having” can be used interchangeably. It is to be understood, however, that these examples are provided by way of illustration and nothing therein should be taken as a limitation upon the overall scope of the invention.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications and patents specifically mentioned herein are incorporated by reference for all purposes including describing and disclosing the chemicals, instruments, statistical analysis and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

### RELATED PUBLICATIONS

1. Paunesku, T., et al., Gadolinium-conjugated TiO2-DNA oligonucleotide nanoconjugates show prolonged intracellular retention period and T1-weighted contrast enhancement in magnetic resonance images. 3, Nanomedicine, 2008, 4(3): 201-207.
2. Paunesku, T., et al., Biology of TiO₂-Oligonucleotide nanocomposites. Nat Mater, 2003, 2(5): 343-346.
3. Paunesku, T., et al., Intracellular distribution of TiO2-DNA oligonucleotide nanoconjugates directed to nucleolus and mitochondria indicates sequence specificity. 3, Nano Lett, 2007, 7(3): 596-601.
4. Brown, E. M., et al., Methods for assessing DNA hybridization of peptide nucleic acid titanium dioxide nanoconjugates. 2, Anal Biochem, 2008, 383(2): 226-235.
5. Wu, A., et al., Titanium dioxide nanoparticles assembled by DNA molecules hybridization and loading of DNA interacting proteins. Nano, 2008, 3(1): 27-36.
6. Thurn, K. T., et al., Endocytosis of titanium dioxide nanoparticles in prostate cancer PC-3M cells. Nanomedicine, 2011, 7(2): 123-130.
7. Thurn, K. T., et al., Labeling TiO₂ Nanoparticles with dyes for optical fluorescence microscopy and determination of TiO₂-DNA nanoconjugate stability. Small, 2009, 5(11): 1318-1325.
8. Park, E. J., et al., Oxidative stress and apotosis induced by titanium dioxide nanoparticles in cultured BEAS-2B cells. Toxicol Lett, 2008, 180(3): 222-229.
9. Thevenot, P., et al., Surface chemistry influences cancer killing effect of TiO2 nanoparticles. Nanomed-Nanotechnol, 2008, 4(3): 226-236.
10. Ashikaga, T., et al., Effect of the photocatalytic activity of TiO₂ on plasmid DNA. Mutat Res, 2000, 466(1): 1-7.
11. Long, T. C., et al., Titanium dioxide (P25) produces reactive oxygen species in immortalized brain microglia (BV2): Implications for nanoparticle neurotoxicity. Environ Sci Technol, 2006, 40(14): 4346-4352.
12. Liu, G. L., et al., Photooxidation mechanism of dye alizarin red in TiO₂ dispersions under visible illumination: An experimental and theoretical examination. J Molec Catal A, 2000, 153: 221-229.
13. Asahi, R., et al., Electronic and optical properties of anatase TiO₂. Phys. Rev. B, 2000, 61(11): 7459-7465.
14. Rajh, J., et al., Surface restructuring of nanoparticles: An efficient route for ligand-metal oxide crosstalk. J Phys Chem B, 2002, 106(41): 10543-10552.
15. Sugden, J. K., et al., Charge transfer across the nanocrystalline-DNA. Biotech Histochem, 2004, 79(2): 71-90.
16. Michelmore, A., et al., The interaction of linear polyphosphates with titanium dioxide. Phys Chem Chem Phys, 2000, 2(13): 2985-2992.
17. Arsac, F., et al., DNA damage photoinduced by titanium dioxide in the presence of anionic vesicles under UV illumination: Influence of sodium chloride concentration. J Oleo Sci, 2007, 56(11): 595-601.
18. Gole, J. L., et al., Highly efficient formation of visible light tunable TiO₂-xNx photocatalysts and their transformation at the nanoscale. J Phys Chem B, 2004, 108(4): 1230-1240.
19. Hashimonto, K., et al., TiO₂ photocatalysis: A historical overview and future prospects. Japan J Appl Phys, 2005, 44(12): 8269-8285.
20. Blatnik, J., et al. Dye Surface Coating Enables Visible Light Activation of TiO₂ Nanoparticles Leading to Degradation of neighboring Biological Structures. Microscopy and Microanalysis. 2012, 18: 134-142.
21. Kamps K., et al. Surface modification of the TiO₂ nanoparticle surface enables fluorescence monitoring of aggregation and enhanced photoreactivity. Integrative Biology. 2013, 5:133-143.

We claim:

1. A multifunctional nanoconjugate comprising:
a metal oxide nanoparticle; and
at least one dye ligand conjugated to the metal oxide nanoparticle.

2. The nanoconjugate of claim 1, wherein the metal oxide nanoparticle is TiO₂.

3. The nanoconjugate of claim 1, wherein the metal oxide nanoparticle is 20 nm or less in diameter.

4. The nanoconjugate of claim 1, wherein the nanoparticle is 6 nm in diameter.

5. The nanoconjugate of claim 1, wherein the dye ligand comprises at least one type of fluorescent dye having visible light absorbance.

6. The nanoconjugate of claim 5, wherein the fluorescent dye is selected from the group consisting of: alizarin red S, alizarin blue black b (ABBB), mordant orange 1 (MO1), alizarin yellow gg (AYGG), N-719, resazurin sodium salt (RSS), and acid green 25 (AG25), or a mixture thereof.

7. A method of preparing a multifunctional nanoconjugate comprising the steps of:
providing a metal oxide nanoparticle;
providing a dye ligand; and
reacting the metal oxide nanoparticle with the dye ligand, so as to attach at least one dye ligand to the metal oxide nanoparticle to form a dye-coated metal oxide nanoparticle.

8. The method of claim 7, wherein the metal oxide nanoparticle is TiO₂.

9. The method of claim 7, wherein the metal oxide nanoparticle is 20 nm or less in diameter.

10. The method of claim 7, wherein the metal oxide nanoparticle is about 6 nm in diameter.

11. The method of claim 7, wherein the dye ligand comprises at least one type of fluorescent dye having visible light absorbance.

12. The method of claim 11, wherein the fluorescent dye is selected from the group consisting of: alizarin red S, alizarin blue black b (ABBB), mordant orange 1 (MO1), alizarin yellow gg (AYGG), N-719, resazurin sodium salt (RSS), and acid green 25 (AG25), or a mixture thereof.

13. A method for destructive sorption of a target biological agent comprising:
providing a quantity of nanoconjugates, wherein the nanoconjugates comprises a metal oxide nanoparticle and at least one dye ligand conjugated to the metal oxide nanoparticle; and
contacting the nanoconjugates with a target biological agent.

14. The method of claim 13, wherein the metal oxide nanoparticle is TiO₂.

15. The method of claim 13, wherein the metal oxide nanoparticle is 20 nm or less in diameter.

16. The method of claim 13, wherein the metal oxide nanoparticle is approximately 6 nm in diameter.

17. The method of claim 13, wherein the dye ligand comprises at least one type of fluorescent dye having visible light absorbance.

18. The method of claim 17, wherein the fluorescent dye is selected from the group consisting of: alizarin red S, alizarin blue black b (ABBB), mordant orange 1 (MO1), alizarin yellow gg (AYGG), N-719, resazurin sodium salt (RSS), and acid green 25 (AG25), or a mixture thereof.

19. The method of claim 13, wherein the biological agent is selected from the group consisting of bacteria, viruses, nucleic acids, cells or the mixture thereof.

20. The method of claim 19, wherein the bacteria is gram positive bacteria.

21. The method of claim 19, wherein the bacteria is selected from the group consisting of B. subtilis, B. globigii and B. cereus, or a mixture thereof.

22. The method of claim 19, wherein the bacteria is gram negative bacteria.

23. The method of claim 19, wherein the bacteria is selected from the group consisting of E. coli, and E. Herbicola, or a mixture thereof.
